(19) United States
(12) Patent Application Publication
(10) Pub. No.: US 2026/0118789 A1
(43) Pub. Date: Apr. 30, 2026

(54) TONER, PROCESS CARTRIDGE, AND IMAGE FORMING APPARATUS

(71) Applicant: CANON KABUSHIKI KAISHA, Tokyo (JP)

(72) Inventors: KENYA TERADA, Shizuoka (JP); YUU SASANO, Shizuoka (JP); TOHRU HIRAMATSU, Shizuoka (JP); SHOHEI SHIBAHARA, Shizuoka (JP); HIROKI KAGAWA, Shizuoka (JP)

(21) Appl. No.: 19/362,598

(22) Filed: Oct. 20, 2025

(30) Foreign Application Priority Data
Oct. 28, 2024 (JP) 2024-189148
Sep. 26, 2025 (JP) 2025-160046

(51) Int. Cl. G03G 9/087; G03G 15/08; G03G 21/18

(52) U.S. Cl. CPC G03G 9/08711; G03G 9/08755; G03G 15/0808; G03G 21/1814; G03G 2215/0607

(57) ABSTRACT

A toner comprising a toner particle and an external additive, wherein the toner particle comprises a binder resin and a positive charge control agent, the binder resin comprises a resin having a styrene acrylic portion and a polyester portion, the polyester portion comprises a monomer unit corresponding to alkenyl succinic acid, the external additive comprises a silica fine particle coated with an aluminum compound, and the aluminum compound is at least one aluminum compound selected from the group consisting of organic aluminum and aluminum hydroxide.

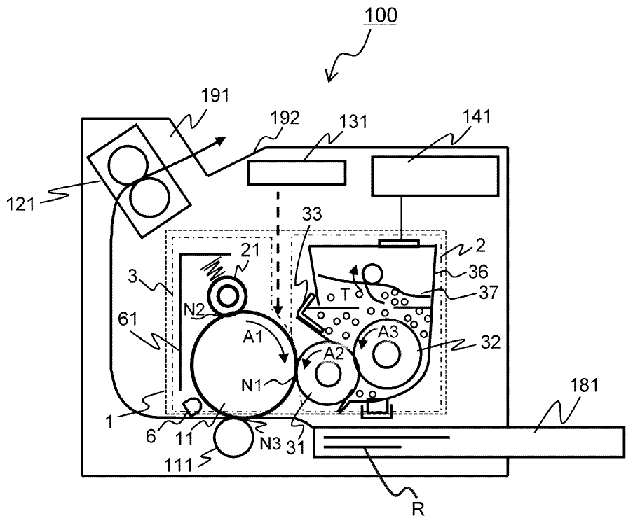

### BACKGROUND

### Field of the Technology

The present disclosure relates to a toner, a process cartridge, and an image forming apparatus to be used in an electrophotographic image forming apparatus.

### Description of the Related Art

In an electrophotographic image forming apparatus, higher speed, reduced power consumption, and longer service life are required. Therefore, further improvement in various performances of toner is also required to enable these.

In particular, in order to achieve higher speed, it is required to lower the fixation temperature of toner. This is because, when the low-temperature fixability of toner is insufficient, the resistance to rubbing of the discharged paper after fixing, i.e., so-called rubbing fixability, tends to decrease. For example, Japanese Patent Application Publication No. 2010-249938 discloses a technique in which low-temperature fixability is improved by including as a monomer a polyester resin containing alkenyl succinic acid in a toner particle and externally adding a polytetrafluoroethylene (PTFE) particle and a silica particle to the toner, thereby improving rubbing fixing performance.

In addition, in order to achieve higher speed, it is required that charging of the toner is rapidly started. This is because, when the charge rising performance of the toner is insufficient, the toner tends to drop due to detachment from a developer carrier. For example, Japanese Patent Application Publication No. 2024-023098 discloses a technique for suppressing toner dropping by improving charging performance through the use of toner containing a crystalline polyester resin in a toner particle and externally adding silica coated with aluminum hydroxide.

### SUMMARY

However, although the toner disclosed in Japanese Patent Application Publication No. 2010-249938 exhibits excellent low-temperature fixability and provides high rubbing fixing performance, since the externally added PTFE particle and silica particle are negatively chargeable, fogging may occur due to a decrease in the rising performance of the positive-charging toner.

In addition, although the toner disclosed in Japanese Patent Application Publication No. 2024-023098 provides a high effect of suppressing toner dropping, since the aluminum hydroxide coating silica is insulating, excessive positive charges may accumulate in the latter half of long-term use, and fogging may occur due to a decrease in the rising performance of the positive-charging toner. In addition, toner melt adhesion may occur after long-term use due to detachment of the aluminum hydroxide-coated silica.

The present disclosure is directed to a toner, a process cartridge, and an image forming apparatus that exhibit excellent low-temperature fixability and are capable of suppressing fogging and toner melt adhesion through long-term use.

The present disclosure relates to a toner comprising a toner particle and an external additive, wherein the toner particle comprises a binder resin and a positive charge control agent, the binder resin comprises a resin having a styrene acrylic portion and a polyester portion, the polyester portion comprises a monomer unit corresponding to alkenyl succinic acid, the external additive comprises a silica fine particle coated with an aluminum compound, and the aluminum compound is at least one aluminum compound selected from the group consisting of organic aluminum and aluminum hydroxide.

The present disclosure relates to a process cartridge attachable to and detachable from an image forming apparatus, the process cartridge comprising: a toner; and a toner container that stores the toner, wherein the toner comprises a toner particle and an external additive, the toner particle comprises a binder resin and a positive charge control agent, the binder resin comprises a resin having a styrene acrylic portion and a polyester portion, the polyester portion comprises a monomer unit corresponding to alkenyl succinic acid, the external additive comprises a silica fine particle coated with an aluminum compound, and the aluminum compound is at least one aluminum compound selected from the group consisting of organic aluminum and aluminum hydroxide.

The present disclosure relates to an image forming apparatus comprising: a toner; a toner carrying member that carries thereon the toner; an electrostatic latent image bearing member; charging means for charging a surface of the electrostatic latent image bearing member by a charging member; electrostatic latent image forming means for forming an electrostatic latent image on charged electrostatic latent image bearing member; developing means for developing the electrostatic latent image using the toner so as to form a toner image on the electrostatic latent image bearing member; transfer means for transferring the toner image onto a recording medium; and fixing means for fixing the toner image, transferred onto the recording medium, to the recording medium, wherein the toner comprises a toner particle and an external additive, the toner particle comprises a binder resin and a positive charge control agent, the binder resin comprises a resin having a styrene acrylic portion and a polyester portion, the polyester portion comprises a monomer unit corresponding to alkenyl succinic acid, the external additive comprises a silica fine particle coated with an aluminum compound, and the aluminum compound is at least one aluminum compound selected from the group consisting of organic aluminum and aluminum hydroxide.

Features of the present disclosure will become apparent from the following description of embodiments with reference to the attached drawings. The following description of embodiments are described by way of example.

### BRIEF DESCRIPTION OF THE DRAWINGS

The FIGURE is a schematic view of an image forming apparatus.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. Also, when numerical ranges are described in a stepwise manner, the upper and lower limits of each of the numerical ranges can be arbitrarily combined. In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ. In the case where XX represents a group, a plurality of members may be selected from XX, and the same is true for YY and ZZ. In addition, the monomer unit refers to a reacted form of a monomer material in a polymer.

A toner ensuring the above-described low-temperature fixability has a problem in that fogging occurs. The present inventors have considered that a PTFE particle and a silica fine particle, which are external additives, are largely involved, and that since these external additives are negatively chargeable, these external additives neutralize the positive charges of the positive-charging toner. In addition, a toner ensuring the positive charging performance as described above may cause fogging and toner melt adhesion in an image after long-term use.

The present inventors have found that an aluminum-coated silica fine particle, such as aluminum hydroxide or organic aluminum, is greatly involved in fogging and toner melt adhesion.

During long-term use, positive charges accumulate on aluminum atoms contained in aluminum hydroxide or organic aluminum. Accordingly, charge unevenness occurs on the surface of the positive-charging toner having an aluminum-coated silica fine particle, and fogging is likely to occur. Furthermore, the aluminum-coated silica fine particle having accumulated positive charges is likely to detach from the positive-charging toner due to electrostatic repulsion. Therefore, the spacer effect provided by the aluminum-coated silica fine particle is less likely to be exhibited, and toner melt adhesion is more likely to occur.

The present inventors focused on the positive charging of the aluminum-coated silica fine particle in the latter stage of the long-term use and conducted extensive studies. As a result, the present inventors have found that, by incorporating a resin having a styrene acrylic portion containing a styrene acrylic resin and a polyester portion having a monomer unit corresponding to alkenyl succinic acid into a toner particle, it is possible to suppress fogging and toner melt adhesion after long-term use. The mechanism is described below.

First, the present inventors focused on styrene of the styrene acrylic portion containing a styrene acrylic resin. Styrene has an aromatic ring. Since the aromatic ring has equal bond lengths and bond angles of six carbons, it forms a regular hexagon and has a planar structure. Since the bonds of all carbons in the aromatic ring are in a conjugated structure, π-electron clouds are formed above and below the aromatic ring. This π-electron cloud forms a cation-π interaction, which is a non-covalent intermolecular interaction, with the aluminum of the organic aluminum and aluminum hydroxide that coat cationic silica.

It is considered that this cation-π interaction neutralizes the excessive positive charges accumulated in the silica fine particle coated with an aluminum compound in the latter half of long-term use, thereby suppressing fogging. Furthermore, the cation-π interaction increases the adhesion of the silica fine particle coated with an aluminum compound to the toner particle. As a result, it is considered that detachment of the silica fine particle coated with an aluminum compound from the toner particle in the latter half of long-term use can be suppressed, and toner melt adhesion can be prevented by facilitating the maintenance of the spacer effect.

In addition, the present inventors focused on a monomer unit corresponding to alkenyl succinic acid (hereinafter, also referred to as “alkenyl succinic acid unit”) included in the polyester portion contained in the toner particle. The long-chain alkyl chain contained in the alkenyl succinic acid unit tends to form gaps between molecules of the material forming the toner particle by exhibiting steric hindrance. In this case, compared to a case without the alkenyl succinic acid unit, the interaction between aromatic rings derived from styrene, that is, a π-π interaction, is less likely to occur. Then, as the aromatic rings in the molecule tend to orient in random directions, the occurrence of cation-π interaction between the aromatic rings and the aluminum cations of the silica fine particle coated with an aluminum compound is promoted. As a result, it is considered that the above-described fogging and toner melt adhesion can be further suppressed.

In view of the above, as a result of extensive studies, the present inventors have found that the following toner can suppress fogging and toner melt adhesion throughout long-term use.

The present disclosure relates to a toner comprising a toner particle and an external additive, wherein the toner particle comprises a binder resin and a positive charge control agent, the binder resin comprises a resin having a styrene acrylic portion and a polyester portion, the polyester portion comprises a monomer unit corresponding to alkenyl succinic acid, the external additive comprises a silica fine particle coated with an aluminum compound, and the aluminum compound is at least one aluminum compound selected from the group consisting of organic aluminum and aluminum hydroxide.

As a result, in the toner of the present disclosure, it was found that fogging and toner melt adhesion can be suppressed throughout a long service life by mitigating the excessive positive charging of the silica fine particle coated with an aluminum compound and suppressing its separation from the toner. Hereinafter, details will be described based on the above mechanism, including the preferred scope of the present disclosure.

The toner has a toner particle and an external additive. The external additive contains a silica fine particle coated with at least one aluminum compound selected from the group consisting of organic aluminum and aluminum hydroxide (hereinafter, also referred to as “aluminum-coated silica fine particle”). As a result, a cation-π interaction is exhibited between the aluminum cation of the coating portion of the fine particle and the aromatic ring of the toner particle, thereby suppressing excessive positive charging of the fine particle and detachment of the fine particle from the toner particle, and enabling suppression of fogging and toner melt adhesion throughout a long service life. Preferably, the aluminum compound that coats the silica is aluminum hydroxide.

A number-average particle diameter of primary particles of the aluminum-coated silica fine particle is, for example, 30 to 110 nm, preferably 40 to 100 nm, and more preferably 50 to 70 nm. When the number-average particle diameter is 40 nm or more, the spacer effect by the fine particle is sufficiently exhibited, and toner melt adhesion in the latter half of long-term use can be further suppressed. In addition, when the number-average particle diameter is 100 nm or less, insufficient embedding of the fine particle in the toner particle can be suppressed, and toner melt adhesion caused by detachment of the fine particle can be further suppressed.

In addition, a content of the silica fine particle coated with an aluminum compound is, for example, 0.5 to 6.0 parts by mass, preferably 1.0 to 5.0 parts by mass, and more preferably 2.0 to 4.0 parts by mass, with respect to 100 parts by mass of the toner particle. When the content of the fine particle is 1.0 part by mass or more, the spacer effect by the fine particle is sufficiently exhibited, and toner melt adhesion in the latter half of long-term use can be further suppressed. In addition, when the content of the fine particle is 5.0 parts by mass or less, detachment caused by electrostatic repulsion between the fine particles can be suppressed, and toner melt adhesion can be further suppressed. A content ratio of the silica fine particle coated with an aluminum compound in the toner is, for example, 0.5 to 6.0% by mass, preferably 1.0 to 5.0% by mass, and more preferably 2.0 to 4.0% by mass.

X₁ represents an Al/Si atomic ratio of the silica fine particle coated with an aluminum compound, which is a ratio of Al to Si measured by X-ray photoelectric spectrophotometry (XPS). In addition, X₂ represents an Al/Si atomic ratio of the silica fine particle coated with an aluminum compound, which is a ratio of Al to Si measured by X-ray fluorescence analysis (XRF). In this case, it is preferable that the ratio value X₁/X₂ of the X₁ to the X₂ satisfies the following Expression (1).

$$0.8 \leq {X}_{1} / {X}_{2} \leq 2. \qquad ( 1 )$$

XPS is an analysis of a range from the surface of the fine particle to a depth of several nanometers, and XRF is a compositional analysis of the entire fine particle. The value of X₁/X₂ within the above range indicates that the aluminum compound is localized within a narrow depth of several nanometers from the surface of the fine particle, indicating that a coating of the aluminum compound is formed on the particle surface.

When X₁/X₂ is 0.80 or more, the aluminum coating has a sufficient thickness, making it possible to maintain an appropriate amount of positive charge on the fine particle in the latter half of long-term use, thereby further suppressing fogging. In addition, when X₁/X₂ is 2.00 or less, the aluminum coating is not excessively thick, and it is possible to more effectively suppress detachment of the fine particle, which occurs due to retention of excessive positive charge by the fine particle in the latter half of long-term use, thereby further suppressing toner melt adhesion.

X₁/X₂ is, for example, 0.20 to 2.00, and more preferably 1.00 to 1.80. It can be controlled by the amount of aluminum used in the production of the aluminum-coated silica fine particle. X₁/X₂ can be easily increased by increasing the amount of a water-soluble aluminum salt, such as an aqueous aluminum chloride solution, with respect to the particle diameter of the silica fine particle substrate. X₁/X₂ can be easily decreased by reducing the amount of a water-soluble aluminum salt, such as an aqueous aluminum chloride solution, with respect to the particle diameter of the silica fine particle substrate. The methods of measuring the values of X₁ and X₂ will be described below.

A coverage ratio of the Al element in the aluminum-coated silica fine particle, calculated from the elemental mapping images of aluminum and silicon obtained by STEM-EDS mapping measurement of the aluminum-coated silica fine particle, is preferably 90% or more. When the coverage ratio is 90% or more, a sufficient amount of an aluminum hydroxide coating is present on the silica surface, which can suppress the relaxation of the positive charging of the positive-charging toner by the silica, thereby further suppressing fogging.

The coverage ratio of the Al element in the aluminum-coated silica fine particle is calculated from the mapping image by defining the number of pixels occupied by silicon as S3 and the number of pixels occupied by aluminum as S4, and then calculating S4/S3×100. A specific method of calculating the coverage ratio will be described below. The coverage ratio of the Al element in the aluminum-coated silica fine particle is, for example, 80 to 100%, preferably 90 to 100%, and more preferably 94 to 100%.

In addition, a coverage ratio W_{AS} (% by area) of the aluminum-coated silica fine particle on the surface of the toner, as calculated from the STEM-EDS mapping image of the toner, is, for example, 2 to 52% by area, preferably 3 to 50% by area, and more preferably 20 to 40% by area. When W_{AS} is 3% by area or more, the spacer effect of the silica fine particle is sufficiently exhibited, and toner melt adhesion can be further suppressed. In addition, when W_{AS} is 50% by area or less, charging unevenness caused by an excessively large amount of the silica fine particles on the toner particle surface can be suppressed, thereby further suppressing fogging. The coverage ratio W_{AS} can be controlled by a number average primary particle diameter of the silica fine particle substrate, the amount of the silica fine particle substrate added, and the external additive treatment conditions. The method of measuring the coverage ratio W_{AS} will be described below.

A powder specific resistivity of the aluminum-coated silica fine particle is, for example, 1.0×10⁷ to 1.0×10¹⁴ Ω·cm, preferably 1.0×10⁸ to 1.0×10¹³ Ω·cm, and more preferably 1.0×10⁹ to 1.0×10¹¹ Ω·cm. When the powder specific resistivity is 1.0×10⁸ Ω·cm or more, the charge rising performance of the toner becomes more preferable, and fogging can be more effectively suppressed. In addition, when a powder specific resistivity of the inorganic fine powder is 1.0×10E¹³ Ω·cm or less, it is possible to suppress the retention of excessive positive charge by the fine particle, thereby more effectively suppressing toner melt adhesion caused by detachment due to electrostatic repulsion between the particles. The powder specific resistivity of the aluminum-coated silica fine particle can be controlled by the number-average primary particle diameter of the silica fine particle substrate. In addition, it can also be controlled by the heating temperature and stirring time used when adjusting the coating amount of aluminum hydroxide. The method of measuring the value of the powder specific resistivity will be described below.

The polyester portion contains a monomer unit corresponding to alkenyl succinic acid. The number of carbon atoms in the alkenyl group of the monomer unit corresponding to alkenyl succinic acid is, for example, 8 to 24, preferably 10 to 22, and more preferably 14 to 18. When the number of carbon atoms is 10 or more, the alkenyl group is sufficiently long, making it easier to form gaps between molecules forming the toner particle due to steric hindrance, thereby promoting a cation-π interaction between the aluminum-coated silica fine particle and the toner particle, and thus more effectively suppressing fogging and toner melt adhesion. In addition, when the number of carbon atoms is 22 or less, inhibition of the cation-π interaction between the fine particle and the toner particle due to the excessive length of the alkenyl group can be suppressed, thereby more effectively suppressing fogging and toner melt adhesion.

The monomer unit corresponding to alkenyl succinic acid is represented, for example, by the following Formula (AS). In Formula (AS), R¹ represents an alkenyl group having 8 to 24 carbon atoms (preferably 10 to 22, and more preferably 14 to 18).

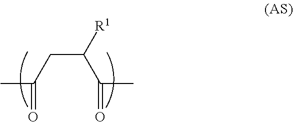

The toner particle preferably contains an ester compound. The ester compound is less likely to inhibit the cation-π interaction between the aluminum-coated silica fine particle and the toner particle, and thus easily suppresses fogging and toner melt adhesion. The ester compound may be a release agent.

The ester compound contained in the toner particle is not particularly limited, and any known ester compound may be used. Examples of the ester compound include at least one ester compound selected from the group consisting of an ester compound of an aliphatic monoalcohol and an aliphatic monocarboxylic acid, an ester compound of an aliphatic polyhydric alcohol and an aliphatic monocarboxylic acid, and an ester compound of an aliphatic polycarboxylic acid and an aliphatic monoalcohol. In addition, examples of the ester compound include an ester compound of an aliphatic polyhydric alcohol and an aliphatic monocarboxylic acid having 10 to 22 carbon atoms, and an ester compound of an aliphatic polycarboxylic acid and an aliphatic monoalcohol having 10 to 22 carbon atoms.

The ester compound preferably contains at least one ester compound selected from the group consisting of an ester compound of pentaerythritol or dipentaerythritol and a saturated or unsaturated aliphatic monocarboxylic acid having 10 to 22 carbon atoms (preferably 14 to 18 carbon atoms). The neopentyl skeleton contained in pentaerythritol and dipentaerythritol is bulky and stable against nucleophilic reactions, and is less likely to inhibit the cation-π interaction between the aluminum-coated silica fine particle and the toner particle, thereby tending to further suppress fogging and toner melt adhesion. In addition, when the number of carbon atoms in the aliphatic monocarboxylic acid is 10 to 22, it becomes approximately the same as the number of carbon atoms in the alkenyl group of the alkenyl succinic acid contained in the toner particle, thereby increasing affinity. As a result, the uniform dispersibility of the ester compound is enhanced, and the low-temperature fixability is further improved.

The aliphatic monocarboxylic acid preferably has an alkyl group or an alkenyl group having 10 to 22 carbon atoms (preferably 14 to 18 carbon atoms). For example, an absolute value of a difference between the number of carbon atoms in the alkenyl group of the monomer unit corresponding to the alkenyl succinic acid and the number of carbon atoms in the alkyl group or the alkenyl group in the ester compound is preferably 0 to 8, 0 to 6, 0 to 4, or 0 to 2.

Hereinafter, preferred components and embodiments of the toner particle will be described.

### Binder Resin

The toner particle contains a binder resin. The binder resin contains a resin having a styrene acrylic portion and a polyester portion. The polyester portion contains a monomer unit corresponding to alkenyl succinic acid. A content of the binder resin is preferably 50% by mass or more of the total amount of the resin components in the toner particle. The content of the binder resin in the total amount of resin components in the toner particle is, for example, 50 to 100% by mass, or 80 to 100% by mass.

The binder resin may contain another resin other than a resin having a styrene acrylic portion and a polyester portion. The other resin may contain, for example, a styrene acrylic resin, an epoxy resin, a polyester resin, a polyurethane resin, a polyamide resin, a cellulose resin, a polyether resin, a mixed resin or a composite resin thereof.

### Resin Having Styrene Acrylic Portion and Polyester Portion

The binder resin contains a resin having a styrene acrylic portion and a polyester portion. The styrene acrylic portion contains, for example, a vinyl polymer such as a styrene acrylic resin. The resin having the styrene acrylic portion and the polyester portion may be, for example, a hybrid resin of a styrene acrylic resin and a polyester resin (polyester portion). The polyester resin contains a monomer unit corresponding to alkenyl succinic acid.

Since the binder resin contains a hybrid resin having a styrene acrylic portion having excellent charging characteristics and a high softening point, and a polyester portion having excellent melting characteristics, it is possible to improve charge stability while increasing the softening point of the binder resin. As a result, the effects of suppressing fogging and toner melt adhesion in long-term durability, as well as the low-temperature fixability, are further enhanced.

Examples of vinyl-based monomers capable of forming the styrene acrylic portion include the following. Examples of vinyl-based monomers constituting the styrene acrylic portion include the following compounds: styrene; styrene derivatives such as o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene; unsaturated monoolefins such as ethylene, propylene, butylene, and isobutylene; unsaturated polyenes such as butadiene and isoprene; halogenated vinyls such as vinyl chloride, vinylidene chloride, vinyl bromide, and vinyl fluoride; vinyl esters such as vinyl acetate, vinyl propionate, and vinyl benzoate; methacrylic esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; acrylic esters such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinylpyrrole, N-vinylcarbazole, N-vinylindole, and N-vinylpyrrolidone; vinyl naphthalenes; and acrylic acid or methacrylic acid derivatives such as acrylonitrile, methacrylonitrile, and acrylamide.

Furthermore, examples thereof include the following: unsaturated dibasic acids such as maleic acid, citraconic acid, itaconic acid, alkenyl succinic acid, fumaric acid, and mesaconic acid; unsaturated dibasic acid anhydrides such as maleic anhydride, citraconic anhydride, itaconic anhydride, and alkenyl succinic anhydride; half esters of unsaturated dibasic acids such as methyl half ester of maleic acid, ethyl half ester of maleic acid, butyl half ester of maleic acid, methyl half ester of citraconic acid, ethyl half ester of citraconic acid, butyl half ester of citraconic acid, methyl half ester of itaconic acid, methyl half ester of alkenyl succinic acid, methyl half ester of fumaric acid, and methyl half ester of mesaconic acid; unsaturated dibasic acid esters such as dimethyl maleate and dimethyl fumarate; α,β-unsaturated acids such as acrylic acid, methacrylic acid, crotonic acid, and cinnamic acid; α,β-unsaturated acid anhydrides such as crotonic anhydride and cinnamic anhydride, and anhydrides of the α,β-unsaturated acids and lower aliphatic acids; and monomers having a carboxyl group such as alkenyl malonic acid, alkenyl glutaric acid, alkenyl adipic acid, acid anhydrides thereof, and monoesters thereof.

In addition, examples thereof include acrylic acid or methacrylic acid esters such as 2-hydroxyethyl acrylate, 2-hydroxyethyl methacrylate, and 2-hydroxypropyl methacrylate, and monomers having a hydroxyl group such as 4-(1-hydroxy-1-methylbutyl)styrene and 4-(1-hydroxy-1-methylhexyl)styrene.

The styrene acrylic portion is preferably polystyrene, a copolymer of styrene and a methacrylic acid ester, a copolymer of styrene and an acrylic acid ester, or a copolymer of styrene and (meth)acrylic acid.

A content ratio of the styrene acrylic portion in the resin having the styrene acrylic portion and the polyester portion is, for example, 10 to 60% by mass, and preferably 20 to 50% by mass.

Examples of polymerization initiators used for polymerization of the styrene acrylic portion include the following: 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutyrate, 1,1′-azobis(1-cyclohexanecarbonitrile), 2-(carbamoylazo)isobutyronitrile, 2,2′-azobis(2,4,4-trimethylpentane), 2-phenylazo-2,4-dimethyl-4-methoxyvaleronitrile, 2,2-azobis(2-methylpropane), ketone peroxides such as methyl ethyl ketone peroxide, acetylacetone peroxide, and cyclohexanone peroxide, 2,2-bis(tert-butylperoxy)butane, tert-butyl hydroperoxide, cumene hydroperoxide, 1,1,3,3-tetramethylbutyl hydroperoxide, di-tert-butyl peroxide, tert-butylcumyl peroxide, dicumyl peroxide, α,α′-bis(tert-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-toluoyl peroxide, di-isopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl) peroxycarbonate, acetylcyclohexylsulfonyl peroxide, tert-butyl peroxyacetate, tert-butyl peroxyisobutyrate, tert-butyl peroxyneodecanoate, tert-butyl peroxy-2-ethylhexanoate, tert-butyl peroxylauroate, tert-butyl peroxybenzoate, tert-butyl peroxyisopropyl carbonate, di-tert-butyl peroxyisophthalate, tert-butyl peroxyallyl carbonate, tert-amyl peroxy-2-ethylhexanoate, di-tert-butyl peroxyhexahydroterephthalate, and di-tert-butyl peroxyazelate.

The polyester portion (polyester resin) is obtained by selecting preferred compounds from a polycarboxylic acid, a polyol, a hydroxycarboxylic acid, and the like and combining the selected compounds, and synthesizing the resin using a conventionally known method such as a transesterification method or a polycondensation method. Preferably, the polyester portion contains a polycondensate of a monomer mixture containing a dicarboxylic acid and a diol.

The polycarboxylic acid is a compound containing two or more carboxyl groups in one molecule. Among them, the dicarboxylic acid is a compound containing two carboxyl groups in one molecule, and is preferably used.

Examples of the dicarboxylic acid include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracene dicarboxylic acid, and cyclohexanedicarboxylic acid.

In addition, examples of the polycarboxylic acids other than the dicarboxylic acid include trimellitic acid, trimesic acid, pyromellitic acid, naphthalene tricarboxylic acid, naphthalene tetracarboxylic acid, pyrene tricarboxylic acid, pyrene tetracarboxylic acid, itaconic acid, glutaconic acid, n-dodecyl succinic acid, n-dodecenyl succinic acid, isododecyl succinic acid, isododecenyl succinic acid, n-octyl succinic acid, and n-octenyl succinic acid. These may be used alone as a single type or in combination with two or more types thereof.

As the dicarboxylic acid, the above alkenyl succinic acid is used. By using alkenyl succinic acid, the polyester portion can contain a monomer unit corresponding to the alkenyl succinic acid. Since the monomer unit corresponding to the alkenyl succinic acid has an alkenyl group with a long carbon chain, steric hindrance is caused between the long alkyl chains adjacent to each other in the toner particle, thereby facilitating the formation of gaps between the alkyl chains. As a result, a π-π interaction between aromatic rings occurring among the long alkyl chains is suppressed, a cation-π interaction between the aromatic rings of the long alkyl chains and the aluminum hydroxide-coated silica is promoted, and fogging and toner melt adhesion in the long-term durability of the toner are suppressed.

A polyol is a compound containing two or more hydroxyl groups in one molecule. Among them, a diol is a compound containing two hydroxyl groups in one molecule and is preferably used.

Specific examples of the diol include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, an alkylene oxide (ethylene oxide, propylene oxide, butylene oxide, or the like) adduct of the bisphenols.

A preferred example among them is an alkylene glycol having from 2 to 12 carbon atoms and an alkylene oxide adduct of a bisphenol, and a particularly preferred example is an alkylene oxide adduct of a bisphenol and a combination thereof with an alkylene glycol having from 2 to 12 carbon atoms. Examples of the alkylene oxide adduct of bisphenol A include compounds represented by the following Formula (A).

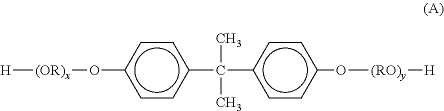

(In Formula (A), R is each independently an ethylene group or a propylene group, x and y are each an integer of 0 or more, and the average value of x+y is from 0 to 10.)

It is preferable that the alkylene oxide adduct of bisphenol A is a propylene oxide adduct and/or an ethylene oxide adduct of bisphenol A. More preferably, it is a propylene oxide adduct. In addition, the average value of x+y is preferably from 1 to 5.

Examples of trihydric or higher alcohols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of the trihydric or higher polyphenols. These may be used alone as a single type or in combination with two or more types thereof.

A content ratio of the polyester portion in the resin having the styrene acrylic portion and the polyester portion is, for example, 40 to 90% by mass, and preferably 50 to 80% by mass.

As a method of hybridizing a styrene acrylic portion and a polyester portion, the method is not particularly limited, and examples thereof include the following. Examples thereof include a method in which a monomer component capable of reacting with both components is included in the styrene acrylic portion and/or the polyester portion, and a method in which a polyester portion is subjected to transesterification with a styrene acrylic portion containing structural units derived from esters. Examples of the monomers capable of reacting with both components include fumaric acid, acrylic acid, methacrylic acid, citraconic acid, maleic acid, and dimethyl fumarate. An acid value of the polyester resin is preferably from 4.0 mgKOH/g to 10.0 mgKOH/g.

Silica Fine Particle Coated with Aluminum Compound

The toner is required to contain, as an external additive, a silica fine particle coated with at least one aluminum compound selected from the group consisting of organic aluminum and aluminum hydroxide. By coating a surface of the silica fine particle with the aluminum compound, it is possible to suppress inhibition of the rise in positive charging of the toner caused by the negative charging performance of the silica and to suppress fogging.

Regarding a coating amount of the aluminum compound, it is preferable that the coating amount is at least a certain level in order to exhibit fogging suppression and toner melt adhesion suppression effects during long-term use. By controlling the conditions during production of the aluminum-coated silica fine particles (such as pH and the temperature during heating), the aluminum can be selectively formed on the surface of the silica fine particles. For example, when a silica fine particle is coated with an aluminum compound, increasing the pH of the reaction solution with an aqueous sodium hydroxide solution or the like tends to reduce the coverage ratio of the Al element in the aluminum-coated silica fine particle. Details will be described below.

It is preferable that the coating amount of the aluminum compound is determined in terms of aluminum oxide, and specifically, is 1 to 30% by mass in terms of aluminum oxide, based on the mass of the silica particle. When the coating amount of the aluminum compound is 1% by mass or more in terms of aluminum oxide, the surface of the silica fine particle serving as the base material can be sufficiently coated, and the effect of improving charging performance during long-term use is further enhanced. On the other hand, when the coating amount of the aluminum compound is 30% by mass or less, the positive charging of the silica fine particle in the long-term durability can be further suppressed, and the effects of suppressing fogging and toner melt adhesion can be more readily obtained.

Examples of the organic aluminum include at least one aluminum chelate compound selected from the group consisting of diisopropoxyaluminum ethyl acetoacetate, isopropoxybis(ethyl acetoacetate)aluminum, aluminum tris(ethyl acetoacetate), and aluminum dibutoxide ethyl acetoacetate.

An aluminum compound that coats the surface of the silica fine particle is preferably aluminum hydroxide. Aluminum hydroxide has a higher hardness than organic aluminum and can exhibit the effects of suppressing fogging and toner melt adhesion over a longer period during long-term durability.

Silica Fine Particle Coated with Aluminum Hydroxide

Examples of methods of coating a silica fine particle with aluminum hydroxide include the following. First, a water-soluble aluminum salt such as aluminum chloride is prepared, and an aqueous solution of the water-soluble salt is added to the silica fine particle. Thereafter, an alkaline substance such as an aqueous sodium hydroxide solution is added to cause hydrolysis of the water-soluble aluminum salt. By this method, the silica particle can be coated with aluminum hydroxide.

Examples of the water-soluble aluminum salt include aluminum chlorides, bromides, sulfates, nitrates, acetates, carbonates, and bicarbonates.

In addition, it is also preferable that the silica fine particle is subjected to surface treatment to render its surface hydrophobic, in order to further improve the charging performance in long-term durability. Examples of the surface treatment include treatment with a silane compound such as silane coupling treatment, and oil treatment, and these treatments may be appropriately selected. In addition, it is also possible to select a plurality of types of surface treatments, and the order of those treatments may be arbitrary. For example, the surface of the silica fine particle may be surface-treated after being coated with the aluminum compound. That is, it is preferable that the aluminum-coated silica fine particle is a surface-treated product of the silica fine particle coated with the aluminum compound.

Examples of silane coupling agents may include hexamethyldisilazane, trimethylsilane, n-propyltrimethoxysilane, n-butyltrimethoxysilane, isobutyltrimethoxysilane, octyltriethoxysilane, decyltriethoxysilane, dodecyltriethoxysilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, triorganosilyl acrylate, vinyldimethylacetoxysilane, dimethylethoxysilane, dimethyldimethoxysilane, diphenyldiethoxysilane, 1-hexamethyldisiloxane, 1,3-divinyltetramethyldisiloxane, 1,3-diphenyltetramethyldisiloxane, and dimethylpolysiloxanes having 2 to 12 siloxane units per molecule, each terminally located siloxane unit containing one hydroxyl group attached to Si. These may be used alone, or two or more kinds may be used in combination.

Preferred silane compounds include alkyltrialkoxysilanes having an alkyl group having 1 to 8 carbon atoms and an alkoxy group having 1 to 3 carbon atoms. Among these alkyltrialkoxysilanes, at least one selected from the group consisting of n-propyltrimethoxysilane, n-butyltrimethoxysilane, and isobutyltrimethoxysilane is preferable. Among these, isobutyltrimethoxysilane is more preferable from the viewpoint of curbing variations in charging performance. Also, the fine particle may be treated with a silicone oil or with a silicone oil and a silane compound in combination.

### Release Agent

The toner particle may contain a release agent. The release agent may be a known release agent.

Specific examples thereof include petroleum-based wax represented by paraffin wax, microcrystalline wax, or petrolatum and derivatives thereof, montan wax and derivatives thereof, hydrocarbon wax obtained by a Fischer-Tropsch method and derivatives thereof, polyolefin wax represented by polyethylene and derivatives thereof, and natural wax represented by candelilla wax and derivatives thereof, and the derivatives also include oxides, block copolymers with a vinyl monomer, and graft modified products.

In addition, the examples thereof include: alcohols such as higher aliphatic alcohols; fatty acids such as stearic acid and palmitic acid, or acid amides, and ketones thereof, and hydrogenated castor oils and derivatives thereof, plant waxes, and animal waxes. These may be used alone or in combination.

Among them, it is preferable to use a polyolefin, a hydrocarbon wax produced by the Fischer-Tropsch method, or a petroleum-based wax, since these tend to improve developing performance and transferability. Note that these waxes may also contain an antioxidant, as long as it is within a range that does not affect the performance of the toner. The release agent preferably contains at least one selected from the group consisting of an ester compound and a hydrocarbon wax, and is more preferably an ester compound. The toner particle may contain both an ester compound and a hydrocarbon wax.

In addition, a content of the release agent is preferably from 1.0 part by mass to 30.0 parts by mass with respect to 100.0 parts by mass of the binder resin. A melting point of the release agent is preferably from 30° C. to 120° C. and more preferably from 60° C. to 100° C. By using a release agent exhibiting the above-described thermal characteristics, the release effect can be efficiently exhibited, and a wider fixing region can be ensured.

### Ester Compound

As described above, the toner particle contains an ester compound. The ester compound may be a release agent. The ester compound is not particularly limited, and any known ester compound used in toner as below can be used.

Specific examples thereof include: esters of a monohydric alcohol and an aliphatic carboxylic acid, such as behenyl behenate, stearyl stearate, and palmityl palmitate, or esters of a monocarboxylic acid and an aliphatic alcohol; esters of a dihydric alcohol and an aliphatic carboxylic acid, such as ethylene glycol distearate, dibehenyl sebacate, and hexanediol dibehenate, or esters of a dicarboxylic acid and an aliphatic alcohol; esters of a trihydric alcohol and an aliphatic carboxylic acid, such as glycerin tribehenate, or esters of a tricarboxylic acid and an aliphatic alcohol; esters of a tetrahydric alcohol and an aliphatic carboxylic acid, such as pentaerythritol tetrastearate or pentaerythritol tetrapalmitate, or esters of a tetrahydric carboxylic acid and an aliphatic alcohol; esters of a hexahydric alcohol and an aliphatic carboxylic acid, such as dipentaerythritol hexastearate and dipentaerythritol hexapalmitate, or esters of a hexacarboxylic acid and an aliphatic alcohol; esters of a polyhydric alcohol and an aliphatic carboxylic acid, such as polyglyceryl behenate, or esters of a polycarboxylic acid and an aliphatic alcohol; and natural ester waxes such as carnauba wax and rice wax. These may be used alone or in combination.

As described above, preferably, the toner particle contains at least one ester compound selected from the group consisting of ester compounds of pentaerythritol or dipentaerythritol and a saturated or unsaturated aliphatic monocarboxylic acid having 10 to 22 carbon atoms. Since pentaerythritol or dipentaerythritol has a three-dimensionally bulky structure, a nucleophilic reaction is hardly generated, and a cation-π interaction generated between the aluminum-coated silica and the aromatic ring of the long-chain alkyl chain is hardly inhibited. Accordingly, it is preferable to suppress toner melt adhesion and fogging. In addition, when the saturated or unsaturated aliphatic monocarboxylic acid has 10 to 22 carbon atoms, the binder resin has a molecular chain having a carbon number approximately equal to that of the alkenyl succinic acid contained therein. This results in high affinity and easy uniform dispersion, which improves low-temperature fixability, and is therefore preferable.

A content of the ester compound is preferably 1.0 to 30.0 parts by mass, more preferably 5.0 to 20.0 parts by mass, and still more preferably 7.0 to 15.0 parts by mass, with respect to 100.0 parts by mass of the binder resin.

### Other External Additives

The toner may contain other external additives in addition to the silica fine particle coated with an aluminum compound. By using the other external additives, it is possible to control, for example, flowability, charging performance, and cleaning performance.

Examples of other external additives include inorganic oxide fine particles such as a silica fine particle, an alumina fine particle, and a titanium oxide fine particle, inorganic stearic acid compound fine particles such as an aluminum stearate fine particle and a zinc stearate fine particle, and inorganic titanate compound fine particles such as strontium titanate and zinc titanate. These external additives may be used alone, or two or more kinds may be used in combination. Also, these particles may be surface-treated with a silane coupling agent, a titanium coupling agent, a silicone oil, and the like.

Other external additives preferably include a silica fine particle. The silica fine particle is preferably spherical silica. Spherical silica is less likely to be embedded in the toner particle, and it is thus easy to maintain fluidity through durable use. Specifically, spherical silica that contains silicon and has an average value of its shape factor SF-1 of from 105 to 120 and an average value of SF-2 of from 100 to 130 is preferable.

Spherical silica is not particularly limited as long as the above conditions are satisfied, and examples thereof include a sol-gel silica particle, a fused silica particle, an organic silicon polymer particle, and combinations thereof. Furthermore, these particles may be surface-treated with a silane coupling agent, a titanium coupling agent, a silicone oil, or the like.

The total amount of these external additives, including the silica fine particle coated with an aluminum compound, is preferably from 0.05 parts by mass to 10.00 parts by mass, and more preferably from 1.0 part by mass to 5.0 parts by mass, with respect to 100 parts by mass of the toner particle.

A known method can be used to fix the external additives to toner particle surface. Examples thereof include fixation using a Henschel mixer (dry method) and a method for achieving fixation by dispersing the toner particle and the external additives in a solvent and then aggregating them (wet method).

### Colorant

The toner particle may include a colorant as needed. The colorant is not particularly limited, and known colorant shown below, for example, can be used.

Examples of yellow pigments include yellow iron oxide, Naples Yellow, Naphthol Yellow S, Hansa Yellow G, Hansa Yellow 10G, Benzidine Yellow G, Benzidine Yellow GR, Quinoline Yellow Lake, condensed azo compounds such as Permanent Yellow NCG and Tartrazine Lake, isoindolinone compounds, anthraquinone compounds, azo metal complexes, methine compounds and allylamide compounds. Specific examples thereof include those listed below. C.I. Pigment Yellow 12, 13, 14, 15, 17, 62, 74, 83, 93, 94, 95, 109, 110, 111, 128, 129, 147, 155, 168 and 180.

Examples of orange pigments include those listed below. Permanent Orange GTR, Pyrazolone Orange, Vulcan Orange, Benzidine Orange G, Indanthrene Brilliant Orange RK and Indanthrene Brilliant Orange GK.

Examples of red pigments include red iron oxide, Permanent Red 4R, Lithol Red, Pyrazolone Red, Watchung Red calcium salt, Lake Red C, Lake Red D, Brilliant Carmine 6B, Brilliant Carmine 3B, condensed azo compounds such as Eosine Lake pigments, Rhodamine Lake B and Alizarin Lake pigments, diketopyrrolopyrrole compounds, anthraquinone compounds, quinacridone compounds, basic dye lake compounds, naphthol compounds, benzimidazolone compounds, thioindigo compounds and perylene compounds. Specific examples thereof include those listed below. C.I. Pigment Red 2, 3, 5, 6, 7, 23, 48:2, 48:3, 48:4, 57:1, 81:1, 122, 144, 146, 166, 169, 177, 184, 185, 202, 206, 220, 221 and 254.

Examples of blue pigments include Alkaline Blue Lake, Victoria Blue Lake, copper phthalocyanine compounds and derivatives thereof, such as Phthalocyanine Blue, metal-free Phthalocyanine Blue, partially chlorinated products of Phthalocyanine Blue, Fast Sky Blue and Indanthrene Blue BG, anthraquinone compounds and basic dye lake compounds. Specific examples thereof include those listed below. C.I. Pigment Blue 1, 7, 15, 15:1, 15:2, 15:3, 15:4, 60, 62 and 66.

Examples of violet pigments include Fast Violet B and Methyl Violet Lake. Examples of green pigments include Pigment Green B, Malachite Green Lake and Final Yellow Green G. Examples of white pigments include hydrozincite, titanium oxide, antimony white and zinc sulfide.

Examples of black pigments include carbon black, aniline black, non-magnetic ferrite, magnetite, and pigments that are colored black through use of yellow colorants, red colorants and blue colorants listed above. It is possible to use one of these colorants in isolation or a mixture of these, and these can be used in the form of solid solutions.

The colorant may be surface-treated with a substance with no polymerization inhibition as needed. The content of the colorant is preferably from 1.0 parts by mass to 15.0 parts by mass relative to 100.0 parts by mass of the binder resin or the polymerizable monomer.

### Positive Charge Control Agent

The toner particle contains a positive charge control agent. A known positive charge control agent may be used. A positive charge control agent that has a high triboelectric charging speed and can stably maintain a constant triboelectric charge quantity is preferable. Furthermore, when the toner particles are produced by a suspension polymerization method, a charge control agent that has low polymerization inhibiting properties and is substantially insoluble in the aqueous medium is particularly preferable.

Examples of the positive charge control agent include the following.

Examples thereof include nigrosine derivatives such as nigrosine and metal salts of fatty acids, guanidine compounds, imidazole compounds, quaternary ammonium salts such as tributylbenzyl ammonium-1-hydroxy-4-naphthosulfonate and tetrabutylammonium tetrafluoroborate, onium salts such as phosphonium salts as analogues thereof, and lake pigments thereof, triphenylmethane dyes and lake pigments thereof (examples of laking agents include phosphotungstic acid, phosphomolybdic acid, phosphotungstomolybdic acid, tannic acid, lauric acid, gallic acid, ferricyanides, and ferrocyanides), metal salts of higher fatty acids, and resin-based charge control agents.

Examples of the charge control resin listed as the positive charge control agent include a polymer or copolymer having a sulfonic acid group, a sulfonate group, or a sulfonic acid ester group. The polymer having a sulfonic acid group, a sulfonate group, or a sulfonic acid ester group is preferably, in particular, a polymer containing a sulfonic acid group-containing acrylamide-based monomer or a sulfonic acid group-containing methacrylamide-based monomer in a copolymerization ratio of 2% by mass or more, more preferably 5% by mass or more.

These positive charge control agents may be added alone or, two or more thereof may be added in combination. A content of the positive charge control agent is preferably from 0.01 parts by mass to 20.0 parts by mass, and more preferably from 0.5 parts by mass to 10.0 parts by mass, with respect to 100.0 parts by mass of the binder resin.

Next, a method of producing toner particles will be described. Hereinafter, an example of a method of obtaining the toner particles will be described, but the method is not limited thereto.

A method of producing toner is not particularly limited, and a known method such as a pulverization method, a suspension polymerization method, a dissolution suspension method, an emulsion aggregation method, or a dispersion polymerization method can be used. As an example, a method of obtaining toner particles by a pulverization method will be described below.

### Raw Material Mixing Step

In the raw material mixing step, materials constituting the toner particle, such as a binder resin, a positive charge control agent, and an ester compound, as well as other components such as a colorant as necessary, are weighed in predetermined amounts, blended, and mixed. As the binder resin, in addition to a resin having a styrene acrylic portion and a polyester portion, other resins may also be used in combination. Examples of mixing apparatuses include a Double Cone Mixer, a V-type mixer, a drum type mixer, a super mixer, a Henschel mixer, a Nauta mixer, and a Mechano hybrid (manufactured by Nippon Coke & Engineering. Co., Ltd.).

### Melt-Kneading Step

Next, the mixed materials are melt-kneaded and a wax and the like are dispersed in a binder resin. In the melt-kneading step, a batch type kneading machine such as a pressure kneader or a Banbury mixer, or a continuous type kneading machine can be used, and single-screw or twin-screw extruders are mainstream due to the advantage of continuous production. Examples thereof include a KTK type twin-screw extruder (manufactured by Kobelco), a TEM type twin-screw extruder (manufactured by Toshiba Machine Co., Ltd.), a PCM kneading machine (manufactured by Ikegai Corporation), a twin-screw extruder (manufactured by KCK Corporation), Buss Ko-Kneader (manufactured by Buss Corporation), and KNEADEX (manufactured by Nippon Coke & Engineering. Co., Ltd.). In addition, the resin composition obtained by melt-kneading may be rolled with two rollers and cooled with water in a cooling step.

In the melt-kneading step, it is preferable to perform melt-kneading using a twin-screw extruder.

A kneading temperature is preferably 110 to 180° C., and more preferably 120 to 170° C. A screw rotation speed during kneading is not particularly limited, and may be appropriately changed according to the apparatus, and is preferably, for example, 1,000 to 1,500 rpm.

### Cooling Step

The cooling step is not particularly limited. Examples thereof include a method in which the kneaded resin composition is rolled with a two-shaft roller or a drum and then cooled with a steel belt cooler (manufactured by Nippon Steel Conveyor Co., Ltd.), and a method of performing rolling while cooling using a press roller and a drum including an internal cooling mechanism such as Belt Drum Flaker (manufactured by Nippon Coke & Engineering. Co., Ltd.). In the cooling step, it is preferable to perform rolling while cooling with Belt Drum Flaker.

### Pulverizing Step

Next, the cooled resin composition is pulverized to a desired particle diameter in the pulverizing step. In the pulverizing step, for example, after coarsely pulverizing in a pulverizer such as a crusher, a hammer mill, or a feathermill, additionally, fine pulverizing is performed in, for example, Cryptotron system (manufactured by Kawasaki Heavy Industries, Ltd.), Super Rotor (manufactured by Nisshin Engineering Inc.), Turbo mill (manufactured by Turbo Industry Co., Ltd.) or an air jet type fine pulverizer.

### Classifying Step

Then, as necessary, classification may be performed using Elbow Jet (manufactured by Nittetsu Mining Co., Ltd.) using an inertial classification system, centrifugal classification type Turboplex (manufactured by Hosokawa Micron Corporation), TSP separator (manufactured by Hosokawa Micron Corporation), Faculty (manufactured by Hosokawa Micron Corporation), a multi-grade classifier utilizing the Coanda effect, an air classifier, or a sieving machine to obtain a toner particle.

### External Addition Step

In the external addition step, an aluminum-coated silica fine particle is externally added to the obtained toner particle. Other known external additives may be used in combination if necessary.

Examples of methods of applying an external additive according to an external addition treatment include a method in which the classified toner particle and various known external additives are added in predetermined amounts, and stirred and mixed using a mixing apparatus such as a Double Cone Mixer, a V-type mixer, a drum type mixer, a super mixer, a Henschel mixer, a Nauta mixer, a Mechano hybrid (manufactured by Nippon Coke & Engineering. Co., Ltd.), or Nobilta (manufactured by Hosokawa Micron Corporation) as an external addition machine.

The external additive mixing time when externally adding an external additive to the toner particle is preferably from 3 to 20 minutes. In addition, the amount of the aluminum-coated silica fine particle added is preferably 0.10 to 5.00 parts by mass with respect to 100.0 parts by mass of the toner particle.

### Image Forming Apparatus

The FIGURE is a view illustrating an example of a schematic configuration of an image forming apparatus according to an aspect of the present disclosure. Referring to the FIGURE, the overall configuration of the image forming apparatus will be described. However, the components, dimensions, arrangements, and the like in the present configuration example are subject to appropriate modification and are not intended to limit the scope of the present disclosure. The FIGURE is a schematic cross-sectional view of an image forming apparatus 100, which is a laser printer capable of forming monochrome (black single-color) images by an electrophotographic system.

The image forming apparatus 100 includes a drum-shaped (cylindrical) photosensitive member (photosensitive drum) 11, which is rotatable and serves as an electrostatic latent image bearing member. When the image forming operation is initiated, the photosensitive member 11 is rotationally driven in the direction of arrow A1 (clockwise direction) in the drawing by a driving force transmitted from a drive motor serving as a drive source constituting the driving unit.

A surface of the rotating photosensitive member 11 is uniformly charged to a predetermined potential of a predetermined polarity, which is a regular polarity of toner, by a charging roller 21, which is a roller-shaped charging member serving as a charging unit. The charging roller 21 has a surface (outer circumferential surface) in contact with the surface (outer circumferential surface) of the photosensitive member 11 to form a charging area N2.

The charging roller 21 is brought into contact with the surface of the photosensitive member 11 with a predetermined pressing force by pressing both ends, in the rotational axis direction, of a conductive support with springs.

The charging roller 21 is rotated in a driven manner in accordance with the rotation of the photosensitive member 11. During the charging process, a predetermined charging voltage (charging bias) is applied to the charging roller 21 at a predetermined timing from a charging power supply serving as a charging voltage application unit. The uniformly charged surface (non-image area) of the photosensitive member 11 is brought to a dark potential.

The surface of the charged photosensitive member 11 is subjected to scanning exposure by an exposure apparatus (laser exposure unit) 131 serving as an exposure unit (electrostatic image forming unit), such that an electrostatic latent image (electrostatic image) is formed on the photosensitive member 11. The exposure apparatus 131 performs exposure by scanning a laser beam on the surface of the photosensitive member 11 in the main scanning direction of the photosensitive member 11 (substantially parallel to the rotation axis direction of the photosensitive member 11) in accordance with image information (image data). In addition, the exposure apparatus 131 repeatedly performs the exposure along the main scanning direction in synchronization with the sub-scanning direction (substantially parallel to the moving direction of the surface of the photosensitive member 11) in accordance with the image information. As a result, an electrostatic latent image is formed on the photosensitive member 11. An exposed area, which is an exposed surface of the photosensitive member 11, (image area), is brought to a light potential.

The electrostatic latent image formed on the photosensitive member 11 is developed (visualized) by supplying a toner T, which serves as a developer, by a developing apparatus (developing unit) 2 serving as a developing unit, thereby forming a toner image (developer image) on the photosensitive member 11. In the present disclosure, the developer stored in the developing apparatus 2 is a one-component toner. Details of the toner are as described above.

The developing apparatus 2 includes a developing roller 31 serving as a toner carrying member (developing member). During development, the surface (outer peripheral surface) of the developing roller 31 is brought into contact with the surface (outer peripheral surface) of the photosensitive member 11 to form a developing area N1. In addition, during development, a predetermined developing voltage (developing bias) is applied to the developing roller 31 from a developing power source serving as a developing voltage applying unit at a predetermined timing. A toner charged to the same polarity as the charging polarity of the photosensitive member 11 adheres to an exposed area (image area) of the photosensitive member 11, in which an absolute value of the potential is reduced by exposure after being uniformly charged (inversion development method).

Since development is performed by a potential difference (development contrast) formed between a development voltage applied to the developing roller 31 and a light potential on the photosensitive member 11, a predetermined development voltage is applied to the developing roller 31. It is assumed that a surface potential formed on the surface of the developing roller 31 is substantially the same as the magnitude of the development voltage applied to the developing roller 31. The developing roller 31 rotates in the direction of arrow A2 (counterclockwise direction) opposite to the photosensitive member 11 (the moving direction at the contact portion is the forward direction). The developing apparatus 2 will also be described below.

A roller-shaped transfer member serving as a transfer unit, which is a transfer roller 111, is disposed to face the photosensitive member 11. The transfer roller 111 is pressed toward the photosensitive member 11 to form a transfer area (transfer nip) N3 at a contact portion between the photosensitive member 11 and the transfer roller 111. A toner image formed on the photosensitive member 11 is transferred, in the transfer area N3, onto a recording material R conveyed while being sandwiched between the photosensitive member 11 and the transfer roller 111 by the action of the transfer roller 111. During transfer, a predetermined transfer voltage (transfer bias) is applied to the transfer roller 111 from a transfer power source serving as a transfer voltage applying unit at a predetermined timing.

A sheet-shaped recording material (transfer material, recording medium, or sheet) R, such as paper, is supplied from a sheet feeding unit 181 to the transfer area N3. The sheet feeding unit 181 may include a cassette serving as a recording material storage unit and a conveying roller serving as a conveying member. The recording material R is conveyed to the transfer area N3 in synchronization with the toner image on the photosensitive member 11.

The recording material R to which the toner image is transferred is conveyed to a fixing apparatus 121 serving as a fixing unit. The fixing apparatus 121 applies heat and pressure to the recording material R carrying the unfixed toner image to fix (melt and fuse) the toner image onto the recording material R. The recording material R to which the toner image is fixed is discharged (output) from a paper discharge area 191 and stacked on a tray 192 provided at an upper portion of the image forming apparatus 100.

Note that, in the present configuration example, the photosensitive member 11, the charging roller 21 serving as a process unit acting on the photosensitive member 11, and the developing apparatus 2 together constitute a process cartridge 1 that is attachable to and detachable from the image forming apparatus 100 as a unit. The transfer roller 111, the exposure apparatus 131, the fixing apparatus 121, the pre-exposure unit 6, the control unit 141 for controlling the developing apparatus 2, and various power supplies are mounted on the image forming apparatus 100. The image forming apparatus and the process cartridge may also include a cleaning blade (not shown) for cleaning the toner from the surface of the photosensitive member 11.

### Process Cartridge

Next, the process cartridge 1 in the present configuration example will be further described.

The process cartridge 1 includes a developing apparatus (developing unit) 2 and a photosensitive member unit 3. The developing apparatus 2 includes, as will be described in detail below, a developing roller 31, a feed roller 32, a developing blade 33, and a developer container 36 that also serves as a developer storage portion. The developer container 36 also serves as a developing frame that supports the developing roller 31, the feed roller 32, and the developing blade 33.

The photosensitive member unit 3 includes the photosensitive member 11 and the charging roller 21, and supports each of them. The developing apparatus 2 and the photosensitive member unit 3 are coupled so that the developing apparatus 2 is swingable relative to the photosensitive member unit 3 about a rotation axis substantially parallel to the rotation axis of the photosensitive member 11. More specifically, the process cartridge 1 is integrated by swingably coupling the developer container (developing frame) 36 of the developing apparatus 2 and a photosensitive member support container (photosensitive member unit frame) 61 of the photosensitive member unit 3

By this configuration, the developing apparatus 2 can move the developing roller 31 between a contact position, in which the developing roller 31 is in contact with the photosensitive member 11, and a separated position, in which the developing roller 31 is separated from the photosensitive member 11. By configuring the developing apparatus 2 to be movable between the contact position and the separated position, unnecessary wear of the developing apparatus 2 and the photosensitive member 11 is suppressed. That is, in the separated position, by stopping the driving of the developing apparatus 2, the rotation of the developing roller 31 and the feed roller 32 is stopped, thereby suppressing consumption of the toner, and by preventing the photosensitive member 11 from contacting with the developing roller 31, wear of a charge transport layer is suppressed.

### Developing Apparatus

Next, the developing apparatus (developing unit) 2 in the present configuration example will be described in more detail. The developing apparatus 2 includes a developing roller 31 serving as a developer carrier (developing member) that carries and conveys the toner as a developer, and supplies the toner to an electrostatic latent image formed on the surface of the photosensitive member 11 to develop the electrostatic latent image. The developing apparatus 2 further includes a feed roller (feed/stripping roller) 32 serving as a developer feed member (developer feed/stripping member) that supplies the toner to the developing roller 31 and also removes the toner from the developing roller 31. The feed roller 32 rotates in the direction of arrow A3.

In addition, the developing apparatus 2 also includes a developing blade 33 serving as a regulating member that regulates the toner supplied onto the developing roller 31 to a predetermined toner amount. The developing apparatus 2 further includes a developer container 36 that forms a toner storage (toner container) 37 therein. A one-component toner serving as a developer is stored in the toner storage 37.

Next, a method for measuring each physical property according to the present disclosure will be described.

Isolation Method of Aluminum-Coated Silica Fine Particle and Method for Measuring Content of Aluminum-Coated Silica Fine Particle Included in Toner

To 100 g of ion exchanged water, 0.50 g of Triton-X100 (manufactured by Kishida Chemical Co., Ltd.) is put to prepare a dispersion medium.
(1) 1.00 g of the toner is weighed exactly in a vial bottle, and the dispersion medium is added to be 10.00 g, and then left for 24 hours to prepare a sample liquid.
(2) The sample liquid is subjected to an ultrasonic homogenizer treatment to release the external additive from the toner and disperse the released external additive in the dispersion medium.
Ultrasound treatment device: Ultrasound homogenizer VP-050 (manufactured by TAITEC Corporation)
Microchip: Stepped microchip, tip diameter p 2 mm
Tip position of microchip: The central portion of the glass vial at a height of 5 mm from the bottom surface of the vial
Ultrasound conditions: Intensity of 30% for 180 mins. At this time, ultrasonic waves are applied while cooling the vial with ice water so that the temperature of the dispersion should not rise.
(3) The toner particle in the sample solution is separated from the dispersion medium (filtrate) in which the external additive is dispersed by suction filtration (10 μm membrane filter).
(4) The filtered toner particle is collected and the dispersion medium is added again to obtain 10.00 g of solution, and then (2) and (3) above are repeated 10 times in total to collect all filtrate.
(5) In a case where other external additives are externally added, the collected filtrate is set in a centrifugal separator to separate other external additives and collect the aluminum-coated silica fine particle.
(6) The collected aluminum-coated silica fine particle is sufficiently dried in a vacuum drier at 60° C. for 24 hours to isolate the dried aluminum-coated silica fine particle.

The mass of the aluminum-coated silica fine particle included in 1.00 g of toner is obtained by measuring the mass of the dried fine particle. Then, a value obtained by multiplying the mass by 100 is regarded as the content (% by mass) of the aluminum-coated silica fine particle in the toner.

### Method of Isolating Toner Particle

In (4) of the above method of isolating the aluminum-coated silica fine particle, the toner particle obtained by repeating filtration a total of 10 times was collected and sufficiently dried at 45° C. for 24 hours, thereby isolating the toner particle.

Method of Isolating Binder Resin from Toner Particle
Method of Separating Binder Resin from Toner Particle

100 mg of the toner particle is dissolved in 3 ml chloroform. Next, the insoluble matter is removed by suction filtration with a syringe fitted with a sample treatment filter (pore size of from 0.2 μm to 0.5 μm, for example, using a Myshori Disk H-25-2 (manufactured by Tosoh Co.)). Soluble matter is introduced into prep-HPLC (apparatus: LC-9130 manufactured by Japan Analytical Industry Co., Ltd., two NEXT preparative columns [60 cm] exclusion limit: 20000, 70000 connected) and chloroform eluent is sent. When the peak can be checked through the acquired chromatographic display, the retention time at which the molecular weight is 2,000 or more is collected in the monodispersed polystyrene standard sample. The solution of the obtained fraction is dried and solidified to separate the binder resin from the release agent.

### Method of Measuring Number-Average Particle Diameter (D1) of Primary Particles of Aluminum-Coated Silica Fine Particle

A number-average particle diameter (D1) of the primary particles of the aluminum-coated silica fine particle is measured using a scanning electron microscope “S-4800” (trade name; manufactured by Hitachi, Ltd.).

By observing the toner to which the aluminum-coated silica fine particle is externally added, in a field magnified up to 200,000 times, the major axis of 100 randomly selected primary particles of the aluminum-coated silica fine particle is measured, and the number-average particle diameter (D1) is determined. An observation magnification is adjusted, as appropriate, depending on the size of the inorganic fine powder.

The aluminum-coated silica fine particle can be distinguished from other external additives by the following method. At the time of acquiring an electron microscope image, an elemental mapping image is simultaneously obtained using energy-dispersive X-ray spectroscopy, and particles present at positions where silicon and aluminum are detected are identified as the aluminum-coated silica fine particles. The major axis is measured to determine the number-average particle diameter (D1).

### Method of Measuring Contents of Aluminum and Silicon and Al/Si Atomic Ratio X₂ in Aluminum-Coated Silica Fine Particle

The contents of aluminum and silicon and the Al/Si atomic ratio X₂ in the aluminum-coated silica fine particle can be calculated by measuring, by X-ray fluorescence analysis (XRF), the aluminum-coated silica fine particle isolated by the above method.

As the measurement apparatus, a wavelength-dispersive X-ray fluorescence analyzer “Axios” (manufactured by PANalytical) and the attached dedicated software “SuperQ ver.4.0F” (manufactured by PANalytical) for setting measurement conditions and analyzing measurement data are used. Under a He atmosphere, elements from Na to U in the aluminum-coated silica fine particle are directly measured.

A liquid-sample cup attached to the apparatus is used, a 6-μm-thick Mylar film is stretched over the bottom surface, and a sufficient amount of the isolated inorganic fine powder is placed in the cup, a layer having a uniform thickness is formed on the bottom surface, and the cup is covered with a lid. The net intensities of the aluminum element and the silicon element obtained by measurement under an output condition of 2.4 kW are taken as the contents of aluminum and silicon in the aluminum-coated silica fine particle. The intensity ratio Al (kcps)/Si (kcps) is defined as the Al/Si atomic ratio X₂ in the aluminum-coated silica fine particle.

### Method of Measuring Contents of Aluminum and Silicon on Surface and in Vicinity of Surface of Aluminum-Coated Silica Fine Particle and Al/Si Atomic Ratio X₁

The contents of aluminum and silicon on the surface and in the vicinity of the surface of the aluminum-coated silica fine particle and the Al/Si atomic ratio X₁ can be calculated by measuring the fine particle isolated by the above method using X-ray photoelectric spectrophotometry (XPS). The XPS apparatus and measurement conditions are as follows.
Apparatus used: Quantum 2000 manufactured by ULVAC-PHI, Inc.
Analytical method: narrow analysis
Measurement conditions:
X-ray source: Al-Kα
X-ray conditions: beam diameter 100 μm, 25 W, 15 kV
Photoelectronic uptake angle: 450
PassEnergy: 58.70 eV
Measurement range: φ100 μm

In the analysis method, the peak derived from the C—C bond of the carbon is orbital is first corrected to 285 eV. Then, the peak area derived from the silicon 2p orbital, whose peak top is detected from 100 eV to 105 eV, and the peak area derived from the aluminum 2p orbital, whose peak top is detected from 72.5 eV to 74.6 eV, are confirmed. From these peak areas, using the relative sensitivity factors provided by ULVAC-PHI, the proportion A (atomic %) of silicon atoms and the proportion B (atomic %) of aluminum atoms in the aluminum-coated silica fine particle are calculated. From the ratio B/A, the Al/Si atomic ratio X₁, which is the value of the ratio of Al to Si on the surface of the aluminum-coated silica, is calculated.

### Method for Measuring X-Ray Diffraction Pattern of Aluminum-Coated Silica Fine Particle

The crystal system of aluminum-coated silica fine particle can be identified by X-ray diffraction analysis of the aluminum-coated silica fine particle taken from the toner.

The X-ray diffraction measurement uses a measuring instrument, “RINT-TTRII” (manufactured by Rigaku Corporation), and control software and analysis software attached to the instrument. The measurement conditions are as described below.

$$X - ray : Cu / 50 kV / 300 mA$$

Goniometer: Rotor horizontal goniometer (TTR-2)
Attachment: Standard sample holder
Divergent slit: Release
Divergence vertical restriction slit: 10.00 mm
Scattering slit: Opened
Light-receiving slit: Opened
Counter: Scintillation counter
Scanning mode: Continuous
Scanning speed: 4.0000°/min
Sampling width: 0.0200°
Scanning axis: 2θ/deg
Scanning range: 3.0000° to 60.0000°

The resulting spectra are analyzed by software attached to the device to identify crystalline structures. In a case where the aluminum-coated silica fine particle is composed of amorphous silica and aluminum hydroxide, no clear peaks are detected. Meanwhile, in a case where the aluminum component contains aluminum oxide (Al₂O₃), clear peaks reflecting the alumina crystalline structure are detected.

### Method for Measuring Weight-Average Particle Diameter (D4) and a Number-Average Particle Diameter (D1) of Toner

A weight-average particle diameter (D4) and a number-average particle diameter (D1) of the toner or the toner particles are measured with 25,000 effective measurement channels using a precision particle size distribution measuring device “Coulter Counter Multisizer 3” (registered trademark, manufactured by Beckman Coulter, Inc.) by a pore electrical resistance method provided with an aperture tube of 100 μm and a dedicated software “Beckman Coulter Multisizer 3 Version 3.51” (manufactured by Beckman Coulter, Inc.) attached for setting measurement conditions and analyzing measurement data, and the measurement data is analyzed and calculated.

As an electrolyte aqueous solution used for the measurement, a solution prepared by dissolving special grade sodium chloride in ion exchange water to a concentration of about 1% by mass, for example, “ISOTON II” (commercially available from Beckman Coulter, Inc.) can be used.

Before the measurement and the analysis, the dedicated software is set as described below.

On the “standard measurement method (SOM) change screen” of the dedicated software, the total count number in the control mode is set to 50000 particles, the number of times of measurements is set to one, and the Kd value is set to a value obtained using “standard particle 10.0 μm” (manufactured by Beckman Coulter, Inc.). When the threshold/noise level measurement button is pressed, the threshold and the noise level are automatically set. In addition, the current is set to 1600 μA, the gain is set to 2, the electrolyte solution is set to ISOTON II, and the box “flush aperture tube after measurement” is checked.

In the “Setting screen for converting pulse to particle diameter” in the dedicated software, set the bin interval to the logarithmic particle diameter, set the particle diameter bin to 256 particle diameter bin, and set the particle diameter range to from 2 μm to 60 μm.

The specific measurement method is as follows.
(1) 200 ml of lectrolyte aqueous solution described above is put into a 250 ml round-bottom glass beaker dedicated to Multisizer 3, which is set on a sample stand, and stirring rods are stirred counterclockwise at 24 rotations/sec. Then, contaminants and air bubbles in the aperture tube are removed by the function “flush aperture tube” in the dedicated software.
(2) The aqueous electrolytic solution: 30 ml is put into a 100 ml flat-bottom glass beaker. To this solution, 0.3 ml of a diluted solution prepared by diluting “Contaminon N” (a 10% by mass aqueous solution of a neutral detergent with pH 7 for washing precision measurement instruments, including a nonionic surfactant, an anionic surfactant, and an organic builder, manufactured by Wako Pure Chemical Industries, Ltd.) with ion exchange water to 3 times by mass is added as a dispersing agent.
(3) Two oscillators with an oscillating frequency of 50 kHz and with phases shifted by 180 degrees are incorporated, a predetermined amount of ion exchange water is put into a water tank of an ultrasonic disperser “Ultrasonic Dispersion System Tetora150” with an electrical output of 120 W (commercially available from Nikkaki Bios Co., Ltd.), and about 2 ml of Contaminon N described above is added to this water tank.
(4) The beaker in (2) is set in a beaker fixing hole of the ultrasonic disperser, and the ultrasonic disperser is operated. The height position of the beaker is adjusted so that the resonance state of the liquid level of the electrolyte aqueous solution in the beaker is maximized.
(5) While the electrolyte aqueous solution in the beaker in (4) is irradiated with ultrasonic waves, 10 mg of the toner is added little by little to the electrolyte aqueous solution and dispersed. Then, the ultrasonic dispersion treatment is further continued for 60 seconds. Upon the ultrasonic dispersion, the water temperature in the water tank is appropriately adjusted from 10° C. to 40° C.
(6) The electrolyte aqueous solution in (5) in which the toner is dispersed is added dropwise to the round bottom beaker in (1) installed in a sample stand using a pipette, and a measurement concentration is adjusted to 5%. Then, the measurement is performed until the number of measurement particles reaches 50,000.
(7) Measurement data is analyzed with the dedicated software attached to the device, and the weight-average particle diameter (D4) and the number-average particle diameter (D1) are calculated. Note that “arithmetic diameter” on the analysis/number statistical value (arithmetic average) screen and “arithmetic diameter” on the analysis/volume statistical value (arithmetic average) screen when graph/number % and graph/volume % are set by the dedicated software are the number-average particle diameter (D1) and the weight-average particle diameter (D4), respectively.

### Composition Analysis of Resin Having Styrene Acrylic Portion and Polyester Portion

The separated chloroform-soluble matter of the binder resin extracted by the above-described method is used as a sample. The sample is adjusted so that the concentration of the toner particle be 0.1% by mass in chloroform, and the solution was filtered through a 0.45 μm PTFE filter, which is then subjected to measurement. The gradient polymer LC measurement conditions are shown below.
Apparatus: UITIMATE3000 (manufactured by Thermo Fisher Scientific)
Mobile phase: A: chloroform (HPLC), B: acetonitrile (HPLC)

$$Gradient : 2 min ( A / B = 0 / 100 ) \to 25 min ( A / B = 100 / 0 )$$

(Note that the gradient of the change in the mobile phase is linear)
Flow velocity: 1.0 mL/min
Injection: 0.1% by mass×20 μL
Column: Tosoh TSKgel ODS (4.6 mmφ×150 mm×5 μm)
Column temperature: 40° C.
Detector: Corona charged particle detector (Corona-CAD) (manufactured by Thermo Fisher Scientific Inc.)

The resin is fractionated at the fractionation times corresponding to the vinyl polymer portion and the polyester portion. In the fractionation, a necessary amount of each chloroform/acetonitrile solution is collected, and after drying and concentration, a resin sample having a styrene acrylic portion and a polyester portion is obtained.

Using a sample of a resin component having a styrene acrylic portion and a polyester portion, the composition ratio and mass ratio are measured by nuclear magnetic resonance spectroscopy (NMR) as follows.

To 20 mg of a sample of a resin component having a styrene acrylic portion and a polyester portion, 1 mL of deuterated chloroform is added, and the proton NMR spectrum of the dissolved resin is measured. From the obtained NMR spectrum, the molar ratio and mass ratio of each monomer are calculated, and the content ratio of each monomer unit can be determined.

For nuclear magnetic resonance spectroscopy (NMR), the apparatus and measurement conditions shown below can be used.
NMR apparatus: RESONANCE ECX500 manufactured by JEOL Ltd.
Observation nuclei: proton
Measurement mode: single pulse

### Method of Measuring Coverage Ratio W_{AS} of Aluminum-Coated Silica Fine Particle on Surface of Toner

The coverage ratio of the aluminum-coated silica fine particle on the surface of the toner can be calculated from elemental mapping images of carbon, aluminum, and silicon obtained by energy-dispersive spectroscopy (STEM-EDS) using a scanning transmission electron microscope.

In EDS elemental mapping measurement, elemental mapping images can be measured with high sensitivity even for trace elements by using a silicon drift detector having a large detector element area.

By performing statistical analysis on the spectral data of each pixel obtained by EDS mapping measurement, a principal component mapping in which pixels having similar spectra are extracted can be obtained, and mapping in which the components are identified can be performed.

The sample for observation is prepared by the following procedures.

An appropriate amount of a liquid curable epoxy resin is put in an Eppendorf tube, a small amount of toner is added, and the mixture is agitated to disperse the toner. Sample pellets are prepared by leaving them day and night and curing the epoxy resin. Pellets are processed by ultramicrotome (Leica, Inc., FC7) to make 200 nm-thick slices and hold them in a Cu grid mesh with a support film. A thin section prepared by STEM is observed, a thin section in which the top portion of the toner can be identified is selected, and a transmission image in the vicinity of the top portion of the toner is obtained.
STEM-EDS mapping analysis is performed in the following apparatuses and conditions.
Scanning transmission electron microscope; JEM-2800 manufactured by JEOL Ltd.
EDS detector; JED-2300T dry SD100GV detector (detector element area: 100 mm²) available from JEOL Ltd.
EDS Analyzer; NORAN System 7 manufactured by Thermo Fisher Scientific Inc.

### STEM-EDS Conditions

Acceleration voltage for STEM: 200 kV
Magnification: 100,000 times
Probe size: 1 nm
STEM image size; 1,024×1,024 pixels (EDS element mapping images at the same location are gained)
EDS mapping size; 256×256 pixel, Dwell Time; 30 μs, number of integrations; 100 frames

After the end of the measurement, quantitative mapping is obtained by the following analytical process.
Kernel size: 3×3
Quantitative map settings: high (slow)
Filter fit type: high precision (slow)

By the above STEM-EDS analysis, EDS mapping images of the C-K line, the Al-K line, and the Si-K line are obtained. The coverage ratio W_{AS} of the aluminum-coated silica fine particle on the surface of the toner can be measured by analyzing the EDS mapping images obtained above using the image analysis software ImageJ (developed by Wayne Rashand). The procedure will be described below.

### Method of Measuring Number of Pixels S1 Occupied by Aluminum-Coated Silica Fine Particle

The EDS mapping image of the Al-K line and the EDS mapping image of the Si-K line obtained as described above are analyzed using ImageJ.

First, from Type in the Image menu, the mapping image to be analyzed is converted to 8-bit. Next, from Filters in the Process menu, the Median diameter is set to 2.0 pixels to reduce the image noise. Subsequently, from Adjust in the Image menu, Threshold is selected, and for the EDS mapping image of the Al-K line and the EDS mapping image of the Si-K line, the brightness thresholds are set as specified below.
Brightness threshold for the Al detection portion (100 to 256 (256 gradations, reference value))
Brightness threshold for the Si detection portion (120 to 256 (256 gradations, reference value))

Next, the EDS mapping image of the Al-K line and the EDS mapping image of the Si-K line, for which the brightness thresholds are specified, are superimposed. Since the aluminum-coated silica fine particle has aluminum on the surface of the silica particle, in the superimposed EDS mapping images, the particles at positions where the target elements are detected in both the EDS mapping image of the Al-K line and the EDS mapping image of the Si-K line are identified as the aluminum-coated silica fine particles. From the superimposed EDS mapping image, pixels in which only silicon is detected are selected and deleted using Clear in the Edit menu. Among the superimposed EDS mapping images, the remaining pixels in which silicon is detected are the pixels occupied by the aluminum-coated silica fine particle. By selecting Measure in the Analyze menu, the number of pixels S1 occupied by the aluminum-coated silica fine particle is output.

### Method of Measuring Number of Pixels S2 Occupied by Top Portion of Toner

The EDS mapping image of the C-K line obtained as described above is analyzed using ImageJ.

First, from Type in the Image menu, the mapping image to be analyzed is converted to 8-bit. Next, from Filters in the Process menu, the Median diameter is set to 2.0 pixels to reduce the image noise. Subsequently, from Adjust in the Image menu, Threshold is selected, and for the EDS mapping image of the C-K line, the brightness threshold is set as specified below.

### Brightness Threshold for the Toner Top Portion (120 to 256 (256 Gradations, Reference Value))

Since the carbon density at the top portion of the toner is higher than that of the embedding resin portion, the pixels occupied by the top portion of the toner can be identified by the above brightness threshold. By selecting Measure in the Analyze menu, the number of pixels S2 occupied by the top portion of the toner is output.

By measuring the number of pixels S1 occupied by the aluminum-coated silica fine particle and the number of pixels S2 occupied by the top portion of the toner by the above-described method, and calculating S1/S2×100, the coverage ratio W_{AS} (%) of the aluminum-coated silica fine particle on the surface of the toner is calculated.

### Method of Measuring Aluminum Coverage Ratio of Aluminum-Coated Silica Fine Particle

The aluminum coverage ratio of the aluminum-coated silica fine particle can be calculated, similarly to the above method for measuring the coverage ratio W_{AS}, from the elemental mapping images of aluminum and silicon obtained by energy-dispersive spectroscopy (STEM-EDS) using a scanning transmission electron microscope.

An observation sample is prepared by ultrasonically dispersing 10 mg of the aluminum-coated silica fine particle isolated by the above method in 2 ml of isopropyl alcohol, dropping the obtained dispersion onto a Cu grid mesh with a support film, and evaporating the solvent. Note that when the fine particles of the material can be obtained independently, the obtained fine particles may be used as the sample.

STEM-EDS mapping analysis is performed in the following devices and conditions.
Scanning transmission electron microscope; JEM-2800 manufactured by JEOL Ltd.
EDS detector; JED-2300 T dry SD100GV detector (detector element area: 100 mm²) available from JEOL Ltd.
EDS Analyzer; NORAN System 7 manufactured by Thermo Fisher Scientific Inc.

### STEM-EDS Conditions

Acceleration voltage of STEM: 200 kV
Magnification: 1,000,000 times
Probe size: 0.5 nm
STEM image size; 1024×1024 pixels (EDS element mapping images at the same location are acquired.)
EDS mapping size; 256×256 pixels, Dwell time; 30 μs, Accumulation Count: 100 frames

After the end of the measurement, quantitative mapping is acquired by the following analytical process.
Kernel size 3×3
Quantitative map settings: High (slow)
Filter fit type: High precision (slow)

By the above STEM-EDS analysis, an EDS mapping image of the Al-K line and an EDS mapping image of the Si-K line are obtained. The aluminum coverage ratio of the aluminum-coated silica fine particle can be measured by analyzing the EDS mapping images obtained above using the image analysis software ImageJ (developed by Wayne Rashand). The procedure will be described below.

### Method of Measuring Number of Pixels S3 Occupied by Silicon in Aluminum-Coated Silica Fine Particle and Number of Pixels S4 Occupied by Aluminum in Aluminum-Coated Silica Fine Particle

The EDS mapping image of the Al-K line and the EDS mapping image of the Si-K line obtained as described above are analyzed using ImageJ.

First, from Type in the Image menu, the mapping image to be analyzed is converted to 8-bit. Next, from Filters in the Process menu, the Median diameter is set to 2.0 pixels to reduce the image noise. Subsequently, from Adjust in the Image menu, Threshold is selected, and for the EDS mapping image of the Al-K line and the EDS mapping image of the Si-K line, the brightness thresholds are set as specified below.
Brightness threshold for the EDS mapping image of Al-K line (100 to 256 (256 gradations, reference value))
Brightness threshold for the EDS mapping image of Si-K line (120 to 256 (256 gradations, reference value))

In the EDS mapping image of the Si-K line with the brightness threshold specified, Measure is selected from the Analyze menu, and the number of pixels S3 occupied by silicon in the aluminum-coated silica fine particle is output.

Next, the EDS mapping image of the Al-K line and the EDS mapping image of the Si-K line, for which the brightness thresholds are specified, are superimposed. From the superimposed EDS mapping image, the region of pixels in which silicon is detected is selected and extracted using the wand tool. In the region of the extracted pixels selected from the EDS mapping image of the Al-K line with the brightness threshold specified, Measure is selected from the Analyze menu, and the number of pixels S4 occupied by aluminum in the aluminum-coated silica fine particle is output.

By measuring the number of pixels S3 occupied by silicon in the aluminum-coated silica fine particle and the number of pixels S4 occupied by aluminum in the aluminum-coated silica fine particle by the above-described method, and calculating S4/S3×100, the aluminum coverage ratio (%) in the aluminum-coated silica fine particle is calculated.

### Method of Measuring Powder Specific Resistivity of Aluminum-Coated Silica Fine Particle

The powder specific resistivity of the aluminum-coated silica fine particle is measured as follows. As the apparatus, a 6517-type electrometer/high resistance system manufactured by Keithley Instruments is used. Electrodes having a diameter of 25 mm are connected, the aluminum-coated silica fine particle is placed between the electrodes so as to have a thickness of 0.5 mm, and under an applied load of 2.0 N, the distance between the electrodes is measured.

The resistance value when a voltage of 1,000 V is applied to the aluminum-coated silica fine particle for 1 minute is measured, and the powder specific resistivity is calculated using the following equation.

$$Powder specific resistivity ( Ω \cdot cm ) = R \times L$$

R: Resistance value (Ω)
L: Interelectrode distance (cm)

### Method for Measuring Weight-Average Molecular Weight Mw and Number-Average Molecular Weight Mn

The molecular weights of samples such as a polyester resin, crystalline polyester, and styrene acrylic resin are measured as follows by gel permeation chromatography (GPC).

First, each sample is dissolved in tetrahydrofuran (THF). In the case of the polyester resin or the styrene acrylic resin, the polyester resin or the styrene acrylic resin is dissolved in THF at a room temperature over 24 hours. In the case of a crystalline polyester, THF is warmed to 40° C. and the crystalline polyester is dissolved therein, and then left for 24 hours.

The solution in which each sample is dissolved is filtrated through a solvent-resistant membrane filter “Maishoridisk” (manufactured by Tosoh Corporation) with a pore diameter of 0.2 μm to thereby obtain a sample solution. It should be noted that the sample solution is adjusted so that the density of the component soluble in THF be 0.8% by mass. The sample solution is used to perform measurement under the following conditions.
Apparatus: HLC8120GPC (detector: RI) (manufactured by Tosoh Corporation)
Column: Seven connected Shodex KF-801, 802, 803, 804, 805, 806, and 807 columns (manufactured by Showa Denko)
Eluent: Tetrahydrofuran (THF)
Flow Rate: 1.0 ml/min.
Oven temperature: 40.0° C.
Sample Injection Amount: 0.10 ml

In the calculation of the molecular weight of the sample, a molecular weight calibration curve created using a standard polystyrene resin (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation) is used.

### EXAMPLES

The further details of the present disclosure will be described below with reference to Examples and Comparative Examples, but the present disclosure is not limited to these. In the unit “part(s)” used in Examples are on a mass basis unless otherwise specified.

### Production of Binder Resin 1

Bisphenol A ethylene oxide 2 mol adduct: 27 parts by mol
Bisphenol A propylene oxide 2 mol adduct: 73 parts by mol
Terephthalic acid: 82 parts by mol
Fumaric acid: 5 parts by mol
Trimellitic acid: 3 parts by mol
Hexadecenyl succinic acid: 10 parts by mol

70 parts by mass of a mixture of the above polyester monomers was charged into a four-necked flask, a vacuum apparatus, a water-separating apparatus, a nitrogen gas introduction apparatus, a temperature-measuring apparatus, and a stirring apparatus were attached, and the mixture was stirred at 160° C. under a nitrogen atmosphere. Then, 30 parts by mass of vinyl copolymerizable monomers constituting the styrene acrylic portion ([S-1]: styrene 60.0 mol % and 2-ethylhexyl acrylate 40.0 mol %) and 1 part by mass of benzoyl peroxide as a polymerization initiator were added dropwise through a dropping funnel over 4 hours, and a reaction was performed at 160° C. for 5 hours.

Thereafter, the temperature was raised to 230° C., 0.2 parts by mass of dibutyltin oxide was added with respect to the total amount of polyester monomer components (100 parts by mass), and a condensation polymerization reaction was performed for 6 hours. After completion of the reaction, the product was taken out from the vessel, cooled, and pulverized to obtain a binder resin 1, which is a hybrid resin of a styrene acrylic portion and a polyester portion.

### Binder Resins 2 to 5

Binder resins 2 to 5 were obtained in the same manner as the binder resin 1, except that the hexadecenyl succinic acid of the binder resin 1 was replaced with the alkenyl succinic acid shown in Table 1.

TABLE 1

| | Alkenyl succinic acid | Parts by mol |
|---|---|---|
| Binder resin 1 | Hexadecenyl succinic acid | 10 |
| Binder resin 2 | Docosenyl succinic acid | 10 |
| Binder resin 3 | Tetracosenyl succinic acid | 10 |
| Binder resin 4 | Octenyl succinic acid | 10 |
| Binder resin 5 | — | — |

### Production of Ester Compound 1

64 g of pentaerythritol, 569 g of hexadecanoic acid, 6 g of p-toluenesulfonic acid, and 700 g of toluene were mixed and heated to 110° C. to react. The generated water was removed by azeotroping with toluene. The reaction was continued for 4 hours, and when the removal of water ceased, the reaction was terminated. An aqueous sodium hydroxide solution was added to neutralize the reaction mixture, and washing with water was performed. After removing the aqueous layer, toluene was distilled off under reduced pressure to obtain an ester compound 1, which is an ester compound of pentaerythritol and an aliphatic monocarboxylic acid having 16 carbon atoms.

### Production of Ester Compounds 2 to 9

Ester compounds 2 to 9 were obtained in the same manner as the ester compound 1, except that the materials used were changed as shown in Table 2 and the alcohol and carboxylic acid were mixed at the same molar ratio as in the production of the ester compound 1.

TABLE 2

| Ester compound | | |
|---|---|---|
| No. | Alcohol | Carboxylic acid |
| Ester compound 1 | Pentaerythritol | Hexadecanoic acid |
| Ester compound 2 | Pentaerythritol | Palmitoleic acid |
| Ester compound 3 | Dipentaerythritol | Hexadecanoic acid |
| Ester compound 4 | Dipentaerythritol | Palmitoleic acid |
| Ester compound 5 | Pentaerythritol | Decanoic acid |
| Ester compound 6 | Pentaerythritol | Docosanoic acid |
| Ester compound 7 | 1,4-Butanediol | Tetracosanoic acid |
| Ester compound 8 | 1,4-Butanediol | Octanoic acid |
| Ester compound 9 | Behenyl alcohol | Behenic acid |

### Production of Toner Particle 1

Binder resin 1: 100.0 parts
Carbon black (Nipex35, manufactured by Orion Engineered Carbons GmbH) 10.0 parts
Ester compound 1: 10.0 parts
Positive charge control agent (NUBIAN BLACK TN-870, manufactured by ORIENT CHEMICAL INDUSTRIES CO., LTD.) 3.0 parts

The above raw materials were mixed for 3 minutes using a Henschel mixer, then melt-kneaded with a twin-screw extruder PCM-30 heated to 160° C., and, after being cooled on a cooling belt (cooling water at 15° C.), the mixture was coarsely pulverized with a hammer mill. The toner temperature immediately after the discharge port during melt-kneading was 155° C. The coarsely pulverized product was finely pulverized with a turbo mill (manufactured by Turbo Kogyo Co., Ltd.) while adjusting the exhaust temperature to 45° C., and the obtained finely pulverized product was classified with an air classifier to obtain a toner particle 1. The weight-average particle diameter (D4) of the toner particles 1 was 6.9 μm.

### Production of Aluminum-Coated Silica Substrate 1

712.5 g of methanol, 42.0 g of water, and 47.1 g of 28% by mass aqueous ammonia were added to a 3 L glass reactor equipped with a stirrer, a dropping funnel, and a thermometer, and mixed. The obtained mixture was heated to 35° C., and while stirring, the simultaneous addition of 1,100.0 g of tetramethoxysilane and 395.2 g of 5.4% by mass aqueous ammonia was started. The tetramethoxysilane was added over 6 hours, and the aqueous ammonia was added over 5 hours. After completion of the addition, stirring was further continued for 0.5 hours to obtain a suspension of a silica particle.

The obtained silica fine particle was passed through a sieve in a wet manner to remove the coarse particle. Thereafter, the solvent was then removed and dried to obtain a fine particle substrate 1 (sol-gel silica).

### Production of Aluminum-Coated Silica Fine Particle 1 (Silica 1)

100 g of the fine particle substrate 1 obtained by the above production was weighed, dispersed in 2 L of water, and then heated to 80° C. An amount of an aqueous aluminum chloride solution corresponding to 10% by mass in terms of Al₂O₃ relative to the fine particle substrate 1 was added, the pH was adjusted to 5.5 with an aqueous sodium hydroxide solution, and then the mixture was maintained with stirring for 1 hour to coat the surface of the fine particle substrate 1 with aluminum hydroxide.

Next, an amount of isobutyltrimethoxysilane corresponding to 10% by mass relative to the fine particle substrate 1 was added, the pH was adjusted to 7.0 with an aqueous sodium hydroxide solution, and the mixture was maintained with stirring for 1 hour to obtain a slurry of a particle 1 coated with a silane coupling agent. The obtained slurry was filtered, and the residue on the filter medium was washed with water to obtain a wet cake. The wet cake was then dried at 120° C. and pulverized with a media-type fine pulverizer to produce an aluminum-coated silica fine particle 1 (silica 1: aluminum hydroxide-coated silica fine particle). The obtained physical properties are shown in Table 3.

### Production of Toner 1

External addition was performed on the toner particle 1. The following materials were charged into an FM mixer (FM10C type, manufactured by Nippon Coke & Engineering. Co., Ltd.) through which water at 7° C. was circulated in the jacket. After the water temperature in the jacket was stabilized at 7° C.±1° C., mixing was performed for 5 minutes at a peripheral speed of 20 m/sec of the rotary blades to obtain a toner mixture. At this time, the amount of water passed through in the jacket was appropriately adjusted so that the internal temperature of the FM mixer did not exceed 25° C. The toner was sieved with a mesh having an opening of 75 m to obtain a toner 1. The physical properties of the toner 1 are shown in Table 4.
Toner particle 1: 100 parts by mass
Aluminum-coated silica fine particle 1: 3.0 parts by mass
Fumed silica (REOLOSIL QS-30 manufactured by Tokuyama Corporation) 1.0 part by mass

### Production of Aluminum-Coated Silica Fine Particles 2 to 15 (Silica 2 to 15)

Aluminum-coated silica fine particles 2 to 15 (silica 2 to 15) were obtained in the same manner as the aluminum-coated silica substrate 1, except that the dropping amount of methanol, the dropping times of tetramethoxysilane and aqueous ammonia, and the heating temperature of the suspension were appropriately adjusted so as to achieve the physical properties described in Table 3 in the production example of the aluminum-coated silica substrate 1.

### Production of Organic Compound-Coated Silica Fine Particle 16 (Silica 16)

In the same manner as in the production example of the aluminum-coated silica substrate 1, a fine particle substrate 1 was obtained. 100 parts by mass of the fine particle substrate 1 obtained by the above production were placed in a mixer and stirred, while simultaneously replacing the atmosphere with nitrogen and heating to 250° C. While maintaining the fluidized state of the silica by continued stirring and heating, 4 parts by mass of an amino-modified silicone oil (KF-857, manufactured by Shin-Etsu Chemical Co., Ltd.) was sprayed and mixed using a spray nozzle. Thereafter, by continuing the heating and stirring for 1 hour, coating treatment was performed to obtain an organic compound-coated silica fine particle 16 (silica 16).

### Aluminum-Coated Fluorine Fine Particle 1 (Fluorine 1)

An aluminum-coated fluorine fine particle 1 was obtained in the same manner as in the production example of the aluminum-coated silica fine particle 1, except that the fine particle substrate 1 was replaced with a vinylidene fluoride fine particle (Solef, manufactured by Solvay S.A.)

The obtained external additives are shown in Table 3.

TABLE 3

| | Particle | | | |
|---|---|---|---|---|
| | diameter | | | |
| | (nm) of | | Coverage | Powder |
| | external | | ratio | specific |
| External | additive | | of element | resistivity |
| additive | (nm) | X₁/X₂ | Al (%) | (Ω · cm) |
| Silica 1 | 60 | 1.40 | 95 | 1.0 × 10E10 |
| Silica 2 | 60 | 1.40 | 95 | 1.0 × 10E8 |
| Silica 3 | 60 | 1.40 | 95 | 1.0 × 10E13 |
| Silica 4 | 60 | 1.40 | 95 | 1.0 × 10E7 |
| Silica 5 | 60 | 1.40 | 95 | 1.0 × 10E14 |
| Silica 6 | 60 | 1.40 | 90 | 1.0 × 10E7 |
| Silica 7 | 60 | 1.40 | 90 | 1.0 × 10E14 |
| Silica 8 | 60 | 0.80 | 80 | 1.0 × 10E7 |
| Silica 9 | 60 | 2.00 | 80 | 1.0 × 10E14 |
| Silica 10 | 40 | 0.75 | 80 | 1.0 × 10E7 |
| Silica 11 | 100 | 0.21 | 80 | 1.0 × 10E14 |
| Silica 12 | 30 | 0.75 | 80 | 1.0 × 10E7 |
| Silica 13 | 100 | 0.21 | 80 | 1.0 × 10E14 |
| Silica 14 | 30 | 0.75 | 80 | 1.0 × 10E7 |
| Silica 15 | 100 | 0.21 | 80 | 1.0 × 10E14 |
| Silica 16 | 60 | — | — | 1.0 × 10E13 |
| Fluorine 1 | 100 | 0.21 | 80 | 1.0 × 10E14 |

In the table, silica 1 to 15 are aluminum-coated silica fine particles. Silica 16 is an organic compound-coated silica fine particle 16. Fluorine 1 is an aluminum-coated fluorine fine particle 1. The particle diameter is the number-average particle diameter of the primary particles. With respect to the powder specific resistivity, for example, the notation “1.0×10E10” indicates “1.0×10¹⁰”,

### Production Example of Toner Particles 2 to 28

Toner particles 2 to 28 were obtained in the same manner as in the production example of the toner particle 1, except that the blending and production conditions of the materials used were changed so as to provide the binder resin, release agent, and external additive shown in Table 4, Note that, in Example 11, the mixing time for the external addition was changed to 4 minutes, in Example 13, the mixing time for the external addition was changed to 3.5 minutes, and in Example 15, the mixing time for the external addition was changed to 3.5 minutes. The physical properties of the obtained toner particles 2 to 28 are shown in Table 4.

TABLE 4

| | | | | | Number of | Content of Al | Coverage |
|---|---|---|---|---|---|---|---|
| | | Binder | | | carbon atoms | silica | ratio |
| Example | Toner | resin | | External | in alkenyl | (parts by | W_{AS} |
| No. | No. | No. | Release agent | additive | group | mass) | (%) |
| 1 | 1 | 1 | Ester compound 1 | Silica 1 | 16 | 3.0 | 30 |
| 2 | 2 | 1 | Ester compound 2 | Silica 1 | 16 | 3.0 | 30 |
| 3 | 3 | 1 | Ester compound 3 | Silica 1 | 16 | 3.0 | 30 |
| 4 | 4 | 1 | Ester compound 4 | Silica 1 | 16 | 3.0 | 30 |
| 5 | 5 | 1 | Ester compound 5 | Silica 1 | 16 | 3.0 | 30 |
| 6 | 6 | 2 | Ester compound 6 | Silica 1 | 22 | 3.0 | 30 |
| 7 | 7 | 3 | Ester compound 7 | Silica 1 | 24 | 3.0 | 30 |
| 8 | 8 | 4 | Ester compound 8 | Silica 1 | 8 | 3.0 | 30 |
| 9 | 9 | 3 | Ester compound 7 | Silica 2 | 24 | 3.0 | 30 |
| 10 | 10 | 4 | Ester compound 8 | Silica 3 | 8 | 3.0 | 30 |
| 11 | 11 | 3 | Ester compound 7 | Silica 4 | 24 | 0.7 | 3 |
| 12 | 12 | 4 | Ester compound 8 | Silica 5 | 8 | 4.8 | 50 |
| 13 | 13 | 3 | Ester compound 7 | Silica 6 | 24 | 0.6 | 2 |
| 14 | 14 | 4 | Ester compound 8 | Silica 7 | 8 | 5.1 | 51 |
| 15 | 15 | 3 | Ester compound 7 | Silica 8 | 24 | 0.6 | 2 |
| 16 | 16 | 4 | Ester compound 8 | Silica 9 | 8 | 5.1 | 51 |
| 17 | 17 | 3 | Ester compound 7 | Silica 10 | 24 | 1.0 | 2 |
| 18 | 18 | 4 | Ester compound 8 | Silica 11 | 8 | 6.0 | 51 |
| 19 | 19 | 3 | Ester compound 7 | Silica 12 | 24 | 0.5 | 2 |
| 20 | 20 | 4 | Ester compound 8 | Silica 13 | 8 | 6.0 | 51 |
| 21 | 21 | 3 | Ester compound 7 | Silica 14 | 24 | 0.5 | 2 |
| 22 | 22 | 4 | Ester compound 8 | Silica 15 | 8 | 6.0 | 51 |
| 23 | 23 | 3 | Ester compound 9 | Silica 14 | 24 | 0.5 | 2 |
| 24 | 24 | 3 | HNP-9 | Silica 14 | 24 | 0.5 | 2 |
| C.E. 1 | 25 | 1 | Ester compound 1 | Silica 16 | 16 | 3.0 | 30 |
| C.E. 2 | 26 | 1 | Ester compound 1 | Fluorine 1 | 16 | 6.0 | 51 |
| C.E. 3 | 27 | 5 | Ester compound 1 | Silica 1 | — | 3.0 | 30 |
| C.E. 4 | 28 | 1 | Ester compound 7 | Silica 1 | 16 | 3.0 | 30 |

In the table, “C.E.” indicates “Comparative Example”, and the number of carbons in the alkenyl group refers to the number of carbons of the alkenyl group in the monomer unit corresponding to the alkenyl succinic acid contained in the polyester portion.

The content of Al silica is the content (parts by mass) of the external additives described in Table 3, such as the silica fine particles (silica 1 to 15) coated with an aluminum compound, silica 16, and fluorine 1, with respect to 100 parts by mass of the toner particle (that is, the amount of external additives excluding the fumed silica among the external additives).

The coverage ratio W_{AS} is the coverage ratio W_{AS} (% by area) of the aluminum-coated silica fine particle on the surface of the toner, calculated from the STEM-EDS mapping image of the toner. HNP-9 is a paraffin wax manufactured by NIPPON SEIRO CO., LTD.

### Example 1

As an image forming apparatus for toner performance evaluation, a color laser printer, HP LaserJet Enterprise Color M555dn, equipped with a single-component toner contact development blade cleaning system, and its consumable cartridge, the HP 212X black toner cartridge (W2120X) CRG, were modified and used.

The main body was modified so that the process speed would be 150% and printing tests could be performed only at the black station. In addition, the cartridge was modified to increase the volume of the toner container so as to contain the following toner filling amount, and the following evaluations 1 to 3 were performed. In this way, durability evaluation with a longer life could be performed in a main body at a higher speed than before. The evaluation results are shown in Table 5.

### Evaluation 1. Evaluation of Low-Temperature Fixability Under Low-Temperature and Low-Humidity Environment

The toner cartridge filled with 550 g of the evaluation toner and mounted in the above image forming apparatus was left to stand for 48 hours in a low-temperature and low-humidity environment (15° C./10% RH, hereinafter, referred to as the LL environment). Subsequently, while varying the fixation temperature, a solid image for density check was output, and the fixation temperature was confirmed. The lowest temperature at which cold offset did not occur was taken as the fixation temperature, and evaluation was performed based on the criteria below.
A: The fixation temperature is lower than 170° C.
B: The fixation temperature is 170° C. or higher and lower than 180° C.
C: The fixation temperature is 180° C. or higher and lower than 190° C.
D: The fixation temperature is 190° C. or higher.

### Evaluation 2. Evaluation of Fogging in Durability Test Images Under Normal-Temperature and Normal-Humidity Environment

The toner cartridge filled with 550 g of the evaluation toner and mounted in the above image forming apparatus was left to stand for 24 hours under a normal-temperature and normal-humidity environment. Thereafter, under the same normal-temperature and normal-humidity environment, a durability evaluation was performed by outputting 30,000 images of horizontal line patterns with a print percentage of 1.0% and a 5 mm margin, using Vitality (LTR 75 g/m²) manufactured by Xerox Corporation, in LETTER size.

Thereafter, a sheet with a 5 cm×5 cm sticky note attached to the center of the printed surface was set in the cassette, and a full white image was output as the 30,001st sheet (60,001st image)

### Full White Image 1

After peeling off the sticky note of the full white image 1, the reflectance (%) of the portion to which the tag was attached and the reflectance (%) of the portion to which the tag was not attached were measured using a white photometer TC-6DX (manufactured by TokyoDenshoku Co., Ltd.), and the difference between both was measured to calculate as the fogging density (%). Then, the fogging density was evaluated according to the criteria below. The evaluation results are shown in Table 5.

### Evaluation Criteria

A: less than 0.5%
B: 0.5% or more and less than 1.0%
C: 1.0% or more and less than 1.5%
D: 1.5% or more

### Evaluation 3. Evaluation of Toner Melt Adhesion in Durability Test Images Under Normal-Temperature and Normal-Humidity Environment

The level of toner melt adhesion to the charging member and the photosensitive member, caused by contamination of the charging member by the toner, was visually evaluated according to the criteria below, based on the toner melt adhesion state on the surface of the photosensitive member and the resulting effect on the image (white spots) after the long-term use of 30,000 sheets in the above fogging evaluation. The evaluation results are shown in Table 5.

### Evaluation Criteria

A: Not observed
B: Toner melt adhesion is present but slight and not conspicuous.
C: Significant toner melt adhesion is present, and slight spot-like blank dots are observed in solid black images.
D: Significant toner melt adhesion occurs, and image defects in which blank dots appear in a linear form extending over several millimeters are conspicuous.

### Examples 2 to 24 and Comparative Examples 1 to 4

In the same manner as in Example 1, each of the toners in Table 5 was evaluated. The results are shown in Table 5.

TABLE 5

| | | | Evaluation 2 | Evaluation 3 |
|---|---|---|---|---|
| | | Evaluation 1 | Fogging after durability test | Toner melt adhesion after |
| | | Low-temperature fixability | under normal-temperature | durability test under normal- |
| Example | Toner | under low-temperature and | and normal-humidity | temperature and normal- |
| No. | No. | low-humidity environment | environment | humidity environment |
| 1 | 1 | A(160° C.) | A(0.2) | A |
| 2 | 2 | A(161° C.) | A(0.2) | A |
| 3 | 3 | A(156° C.) | A(0.1) | A |
| 4 | 4 | A(158° C.) | A(0.1) | A |
| 5 | 5 | A(166° C.) | A(0.2) | A |
| 6 | 6 | A(169° C.) | A(0.2) | A |
| 7 | 7 | B(171° C.) | A(0.2) | A |
| 8 | 8 | B(171° C.) | A(0.2) | A |
| 9 | 9 | B(171° C.) | A(0.3) | A |
| 10 | 10 | B(172° C.) | A(0.3) | A |
| 11 | 11 | B(172° C.) | A(0.3) | A |
| 12 | 12 | B(172° C.) | A(0.3) | A |
| 13 | 13 | B(173° C.) | A(0.3) | B |
| 14 | 14 | B(173° C.) | A(0.3) | B |
| 15 | 15 | B(173° C.) | A(0.4) | B |
| 16 | 16 | B(174° C.) | A(0.4) | B |
| 17 | 17 | B(174° C.) | B(0.6) | B |
| 18 | 18 | B(175° C.) | B(0.6) | B |
| 19 | 19 | B(175° C.) | B(0.7) | B |
| 20 | 20 | B(176° C.) | B(0.7) | B |
| 21 | 21 | C(181° C.) | C(1.2) | C |
| 22 | 22 | C(183° C.) | C(1.2) | C |
| 23 | 23 | C(185° C.) | C(1.3) | C |
| 24 | 24 | C(188° C.) | C(1.3) | C |
| C.E. 1 | 25 | C(182° C.) | D(1.7) | D |
| C.E. 2 | 26 | C(183° C.) | D(1.7) | D |
| C.E. 3 | 27 | C(182° C.) | D(1.7) | D |
| C.E. 4 | 28 | D(193° C.) | C(1.3) | D |

In the table, “C.E.” indicates “Comparative Example”. The present disclosure can provide a toner, a process cartridge, and an image forming apparatus that exhibit excellent low-temperature fixability and are capable of suppressing fogging and toner melt adhesion through long-term use.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-189148, filed Oct. 28, 2024, and Japanese Patent Application No. 2025-160046, filed Sep. 26, 2025, which are hereby incorporated by reference herein in their entirety.

What is claimed is:

1. A toner comprising a toner particle and an external additive, wherein
the toner particle comprises a binder resin and a positive charge control agent,
the binder resin comprises a resin having a styrene acrylic portion and a polyester portion,
the polyester portion comprises a monomer unit corresponding to alkenyl succinic acid,
the external additive comprises a silica fine particle coated with an aluminum compound, and
the aluminum compound is at least one aluminum compound selected from the group consisting of organic aluminum and aluminum hydroxide.

2. The toner according to claim 1, wherein the aluminum compound is the aluminum hydroxide.

3. The toner according to claim 1, wherein a number-average particle diameter of primary particles of the silica fine particle coated with the aluminum compound is 40 to 100 nm.

4. The toner according to claim 1, wherein a content of the silica fine particle coated with the aluminum compound is 1.0 to 5.0 parts by mass with respect to 100 parts by mass of the toner particle.

5. The toner according to claim 1, wherein a ratio value X₁/X₂ of X₁ to X₂ satisfies Expression (1) below:
$$0.8 \leq {X}_{1} / {X}_{2} \leq 2. , \qquad ( 1 )$$
where X₁ represents an Al/Si atomic ratio of the silica fine particle coated with the aluminum compound measured by X-ray photoelectric spectrophotometry, and X₂ represents an Al/Si atomic ratio of the silica fine particle coated with the aluminum compound measured by X-ray fluorescence analysis.

6. The toner according to claim 1, wherein a coverage ratio of an Al element in the silica fine particle coated with the aluminum compound, calculated from elemental mapping images of aluminum and silicon obtained by STEM-EDS mapping measurement of the silica fine particle coated with the aluminum compound, is at least 90%.

7. The toner according to claim 1, wherein a coverage ratio W_{AS} (% by area) of the silica fine particle coated with the aluminum compound on a surface of the toner, calculated from a STEM-EDS mapping image of the toner, is 3 to 50% by area.

8. The toner according to claim 1, wherein a powder specific resistivity of the silica fine particle coated with the aluminum compound is 1.0×10⁸ to 1.0×10¹³ Ω·cm.

9. The toner according to claim 1, wherein the number of carbon atoms in an alkenyl group of the monomer unit corresponding to the alkenyl succinic acid is 10 to 22.

10. The toner according to claim 1, wherein the toner particle comprises a release agent, and
the release agent comprises at least one selected from the group consisting of an ester compound and a hydrocarbon wax.

11. The toner according to claim 10, wherein
the release agent is the ester compound, and
the ester compound comprises at least one ester compound selected from the group consisting of an ester compound of an aliphatic monoalcohol and an aliphatic monocarboxylic acid, an ester compound of an aliphatic polyhydric alcohol and an aliphatic monocarboxylic acid, and an ester compound of an aliphatic polycarboxylic acid and an aliphatic monoalcohol.

12. The toner according to claim 11, wherein the ester compound comprises at least one ester compound selected from the group consisting of an ester compound of pentaerythritol or dipentaerythritol and a saturated or unsaturated aliphatic monocarboxylic acid having 10 to 22 carbon atoms.

13. A process cartridge attachable to and detachable from an image forming apparatus, the process cartridge comprising:
a toner; and
a toner container that stores the toner,
wherein
the toner comprises a toner particle and an external additive,
the toner particle comprises a binder resin and a positive charge control agent,
the binder resin comprises a resin having a styrene acrylic portion and a polyester portion,
the polyester portion comprises a monomer unit corresponding to alkenyl succinic acid,
the external additive comprises a silica fine particle coated with an aluminum compound, and
the aluminum compound is at least one aluminum compound selected from the group consisting of organic aluminum and aluminum hydroxide.

14. An image forming apparatus comprising:
a toner;
a toner carrying member that carries thereon the toner;
an electrostatic latent image bearing member;
charging means for charging a surface of the electrostatic latent image bearing member by a charging member;
electrostatic latent image forming means for forming an electrostatic latent image on charged electrostatic latent image bearing member;
developing means for developing the electrostatic latent image using the toner so as to form a toner image on the electrostatic latent image bearing member;
transfer means for transferring the toner image onto a recording medium; and
fixing means for fixing the toner image, transferred onto the recording medium, to the recording medium, wherein
the toner comprises a toner particle and an external additive,
the toner particle comprises a binder resin and a positive charge control agent,
the binder resin comprises a resin having a styrene acrylic portion and a polyester portion,
the polyester portion comprises a monomer unit corresponding to alkenyl succinic acid,
the external additive comprises a silica fine particle coated with an aluminum compound, and
the aluminum compound is at least one aluminum compound selected from the group consisting of organic aluminum and aluminum hydroxide.
